(19) United States
(12) Patent Application Publication
(10) Pub. No.: US 2026/0189859 A1
(43) Pub. Date: Jul. 2, 2026

(54) LIGHT-BASED INDICATORS ON HEARING INSTRUMENTS

(71) Applicant: Starkey Laboratories, Inc., Eden Prairie, MN (US)

(72) Inventors: David A. Fabry, Eden Prairie, MN (US); Kyle Olson, St. Louis Park, MN (US); Sidney A. Higgins, Maple Grove, MN (US); Christopher L. Howes, Eden Prairie, MN (US); Jay Stewart, Eden Prairie, MN (US); Ganesh Borra, Plymouth, MN (US)

(21) Appl. No.: 19/429,207

(22) Filed: Dec. 22, 2025

Related U.S. Application Data
(60) Provisional application No. 63/740,153, filed on Dec. 30, 2024.
(60) Provisional application No. 63/915,466, filed on Nov. 11, 2025.

(51) Int. Cl. H04R 25/00; H04R 1/10

(52) U.S. Cl. CPC H04R 25/30; H04R 1/1083; H04R 25/50; H04R 25/554; H04R 25/70; H04R 2225/41; H04R 2420/07; H04R 2460/01

(57) ABSTRACT

This disclosure describes a hearing instrument comprising: a housing, a light source, a receiver, and one or more processors configured to: receive a device-finding signal from an external device, wherein the device-finding signal instructs the hearing instrument to enter a device-finding mode to assist a user in finding the hearing instrument; and in response to receiving the device-finding signal, cause the light source to emit a light signal; determine whether the hearing instrument is currently being worn; cause the receiver to output a first sound based on the hearing instrument currently being worn; and cause the receiver to output a second sound based on the hearing instrument not currently being worn.

This application claims the benefit of U.S. Provisional Patent Application 63/740,153, filed Dec. 30, 2024, and U.S. Provisional Patent Application 63/915,466, filed Nov. 11, 2025, the entire content of each of which is incorporated by reference.

### TECHNICAL FIELD

This disclosure relates to hearing instruments.

### BACKGROUND

Hearing instruments are devices designed to be worn on, in, or near one or more of a user's ears. Common types of hearing instruments include hearing assistance devices (e.g., “hearing aids”), earbuds, headphones, hearables, cochlear implants, and so on. In some examples, a hearing instrument may be implanted or integrated into a user. Some hearing instruments include additional features beyond just environmental sound amplification. For example, some modern hearing instruments include advanced audio processing for improved functionality, controlling and programming the hearing instruments, wireless communication with external devices including other hearing instruments (e.g., for streaming media), and so on.

### SUMMARY

This disclosure describes hearing instruments, such as hearing aids, that include light sources, such as light-emitting diodes (LEDs), which may be used to convey or indicate information about the device, the user, or both. Furthermore, this disclosure describes techniques for locating a hearing instrument. In one example, a hearing instrument includes a housing, a light source, a receiver, and one or more processors. The one or more processors are configured to receive a device-finding signal from an external device, where the device-finding signal instructs the hearing instrument to enter a device-finding mode. In response to receiving the device-finding signal, the one or more processors cause the light source to emit a light signal to assist a user in finding the hearing instrument. The one or more processors may also be configured to determine whether the hearing instrument is currently being worn, for example, using one or more sensors. Based on the hearing instrument currently being worn, the one or more processors may cause the receiver to output a first sound, such as a low-volume notification. Based on the hearing instrument not currently being worn, the one or more processors may cause the receiver to output a second sound, such as a louder tone to audibly assist the search.

In some examples, the one or more processors are configured to enter a low-power mode. This determination may be made, for example, in response to determining that the hearing instrument is not being worn and not in a charger. A charger is a device designed to recharge a battery of the hearing instrument. In some examples, the charger is a case that includes receptacles to hold the hearing instruments. In some examples, the charger includes its own battery to allow the batteries of the hearing instruments to be recharged even when the charger is not plugged in to a wall outlet. It may be unnecessary for hearing instruments to enter the low-power mode when the hearing instruments are in the charger because when the hearing instruments are in the charger, maintaining the hearing instruments at a normal power level does not deplete the batteries of the hearing instruments.

While in the low-power mode, the one or more processors may suspend one or more services and reduce a duty cycle of a radio component to reduce power consumption. For instance, the radio component may wake at periodic intervals to broadcast a ping signal or to monitor for the device-finding signal. Upon receiving the device-finding signal from the external device, the one or more processors may cause the hearing instrument to exit the low-power mode and enter a fully awake state to emit the light signal and/or the second sound. While this low-power mode allows the hearing instrument to be found, the mode still consumes power and may eventually drain the battery. To prevent damage to the battery, the one or more processors may be configured to trigger a complete off state, where the low-power timer is deactivated, in response to determining that a battery charge level has fallen below a predefined safety threshold. This low-power mode provides a significant window for retrieval; for example, this low-power state may be configured to last for several days before the battery protection threshold is met, offering a substantial advantage over conventional systems that cannot be located once powered off.

In some examples, an external device, such as a mobile phone, accessory device, or remote controller, includes a transceiver and one or more processors. The remote controller may be a special-purpose device that includes buttons, dials, and/or other features that enable a user to provide commands to hearing instruments. The remote controller may be configured to communicate with the hearing instrument in one or more ways. For example, the transceiver of the external device may enable wireless communication with the hearing instrument, for example, using a direct wireless pairing. The wireless communication may use various technologies, such as Bluetooth, Near-Field Magnetic Induction (NFMI), or other radio frequency (RF) protocols, including operation in the 2.4 GHz frequency band. In some examples, the external device communicates with the hearing instrument using an infrared beam.

The external device may be configured to transmit the device-finding signal to the hearing instrument. This transmission may be initiated in response to a user selection of a feature on a device-finding interface, a voice command, or a button press on a remote controller. In some examples, the external device transmits the device-finding signal in response to a second signal received from a second device, such as a companion device used by a caregiver. This second signal may be received from a cloud-based service or as a special text message.

The external device may be further configured to provide a user interface. The user interface may contain a map indicating a last known location of the hearing instrument and, in some examples, an indication of a most recent activity the user was engaged in. The user interface may also display a signal strength indicator to facilitate a proximity-based search, and may display an icon that flashes to confirm the hearing instrument's light source is active. In some examples, the light signal emitted by the hearing instrument includes an infrared light signal. The external device may use a camera to detect the infrared light signal and display a live video feed with a visible indication of the source of the infrared light signal.

In one example, a hearing instrument comprises a housing, a light source, a receiver and one or more processors configured to, during a fitting session for the hearing instrument, cause the receiver to output a sound. The one or more processors are further configured to cause the light source to emit a first light signal indicating that the receiver output the sound.

In another example, a method is described that includes causing, by one or more processors, a receiver of the hearing instrument to output a sound. The method further includes causing, by the one or more processors, a light source of the hearing instrument to emit a first light signal indicating that the receiver output the sound.

In another example, a method is described that includes receiving, by one or more processors, video data captured during a fitting session for a hearing instrument and determining, by the one or more processors, based on the video data representing that a light source of the hearing instrument is emitting a light signal, that the hearing instrument delivered a sound to a user of the hearing instrument. The method further includes responsive to determining that the hearing instrument delivered the sound to the user, prompting the user to indicate whether the user heard the sound.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a conceptual diagram illustrating an example system that includes one or more hearing instruments, in accordance with one or more techniques of this disclosure.

FIG. 2 is a block diagram illustrating example components of a hearing instrument, in accordance with one or more techniques of this disclosure.

FIG. 3 is a flowchart illustrating an example operation in accordance with one or more techniques described in this disclosure.

FIG. 4 is a block diagram illustrating an example fitting computing system in accordance with one or more techniques of this disclosure.

FIG. 5 is a flowchart illustrating an example operation of a fitting computing device, in accordance with one or more techniques of this disclosure.

FIG. 6 is a block diagram illustrating an example behind-the-ear hearing instrument in accordance with one or more techniques of this disclosure.

FIG. 7 is a conceptual diagram illustrating an example proper position of a behind-the-ear unit relative to a user's head, in accordance with one or more techniques of this disclosure.

FIG. 8 is a flowchart illustrating an example operation in accordance with one or more techniques of this disclosure.

FIG. 9 illustrates an example user interface for a device-finding feature, in accordance with one or more techniques of this disclosure.

FIG. 10 illustrates an example user interface for a device-finding feature that uses an infrared light signal emitted by a light source of a hearing instrument to help a user find the hearing instrument, in accordance with one or more techniques of this disclosure.

### DETAILED DESCRIPTION

A hearing instrument is a device designed to be worn on or in a user's ear. Example types of hearing instruments include hearing aids, earphones, earbuds, telephone earpieces, and other types of devices designed to be worn on or in a user's ear. As the term is used herein, a hearing instrument, such as a hearing assistance device, a hearing device, and a hearing instrument, refers to any ear-wearable device that is used as a hearing aid, a personal sound amplification product (PSAP), a headphone set, a hearable, a wired or wireless earbud, or other hearing instrument that provides sound to a user for hearing.

Determining the status or condition of a hearing instrument can be challenging through visual observation, particularly when the hearing instrument is worn in a patient's ear. To address this challenge, hearing instruments may include light sources that provide visual feedback or indicators regarding the hearing aid, the wearer's status, or both. This disclosure describes designs for hearing instruments, such as hearing aids, incorporating light sources, such as light-emitting diodes (LEDs). In some examples, a hearing instrument may feature two light sources, such as green and red, which can combine to produce additional colors like yellow or orange. In other examples, the hearing instrument may incorporate three or more light sources, e.g., red, green, and blue, or red, green, blue, and yellow, to generate a broader range of colors, potentially creating a large or near-infinite spectrum. The availability of multiple colors may enhance the clarity and specificity of visual indicators, thereby improving user experience and caregiver communication. The indication from the light source may be output as a report, alert, notification, or summary, providing further details on the status or condition of the hearing instrument. This information can be displayed to be viewed by a doctor, hearing care professional, or other types of people, aiding in the assessment and management of the user's hearing instrument. The report could include specific data such as the frequency and duration of a blink pattern, light color, or intensity, and may be used to evaluate device performance or diagnose issues.

Various placements for the light sources may further improve visibility and usability. For example, a light source positioned on the back of the hearing instrument may provide discreet signaling, while a light source located near the top front of the hearing instrument could allow the user of the hearing instrument to view the light in a mirror or enable others facing the user to observe a light signal emitted by the light source. Placing a light source along the receiver-in-canal (RIC) cable may enhance visibility of a light signal emitted by the light source. In some designs, a light source directed toward the ear may illuminate the entire ear, thereby using skin translucency for a distinctive visual effect. Additionally, hearing instrument 102 may include components (e.g., a faceplate, shell, button cap, or other housing component) that diffuse light. In some examples, a housing component of hearing instrument 102 may include a surface (e.g., a bottom surface) that diffuses light from a light source for applications.

The light signal emitted by a light source may also be context-sensitive, adjusting its color, duration, blink rate, or brightness depending on the status or mode of the hearing instrument. For example, a light signal emitted by a light source could change colors or blink at varying rates to indicate different operational states, such as battery status, self-checks, or alerts. In some designs, the hearing instrument may emit light signals according to a predefined sequence of light signals to convey different types of information, such as indicating that a battery is low or signaling the completion of a self-check. The light source may be controlled through a remote controller, a smartphone, or directly on the hearing instrument itself, such as via a button, inertial measurement unit (IMU), or voice input, allowing for flexible user interaction.

Furthermore, hearing instruments are small, portable devices and are consequently susceptible to being misplaced or lost. Users may manually power down hearing instruments when not in use to conserve battery life. Furthermore, some hearing instruments include an auto-off feature that powers down the device after a period of inactivity or when removed from the ear. Existing solutions for locating a lost hearing instrument typically rely on establishing an active wireless communication link, such as a Bluetooth connection, between the hearing instrument and an external device. If the hearing instrument is powered off, the radio components are inactive, rendering these location features non-functional. This presents a significant challenge, because many hearing instruments are lost while in a powered-down state.

The techniques of this disclosure address this challenge by providing a device-finding capability that functions even when a hearing instrument is in an “off” or low-power state. A hearing instrument may enter a low-power mode when not being worn and not in a charger. In this low-power mode, the hearing instrument suspends one or more services but maintains a low-power timer and periodically activates a radio component at a reduced duty cycle. This periodic activation allows the hearing instrument to monitor for a device-finding signal from an external device, such as a mobile phone or remote controller, or to transmit a periodic broadcast signal. In such examples, the external device and the hearing instrument may have a synchronized schedule of windows in which a device-finding signal may be transmitted and sent. In some examples, the hearing instrument may periodically transmit a request to poll the external device for device-finding signals. Upon receiving a valid device-finding signal, one or more processors in the hearing instrument exit the low-power mode and enter an active device-finding mode.

In the active device-finding mode, the one or more processors cause a light source on the hearing instrument to emit a light signal. This provides a visual cue to help the user locate the device. The techniques also manage audio output intelligently to avoid user discomfort. The one or more processors may determine whether the hearing instrument is currently being worn, for example, using one or more sensors. If the hearing instrument is determined to be worn, the one or more processors cause a receiver to output a first sound, such as a low-volume notification, informing the wearer that the feature is active. In other words, the first sound may notify a user of the hearing instrument that the hearing instrument has received the device-finding signal. If the hearing instrument is determined to not be worn, the one or more processors cause the receiver to output a second, louder sound to audibly assist the user in locating the device. This approach provides a robust method for locating a hearing instrument, increasing the recovery rate for lost devices, while preventing a loud search tone from being output directly into a user's ear.

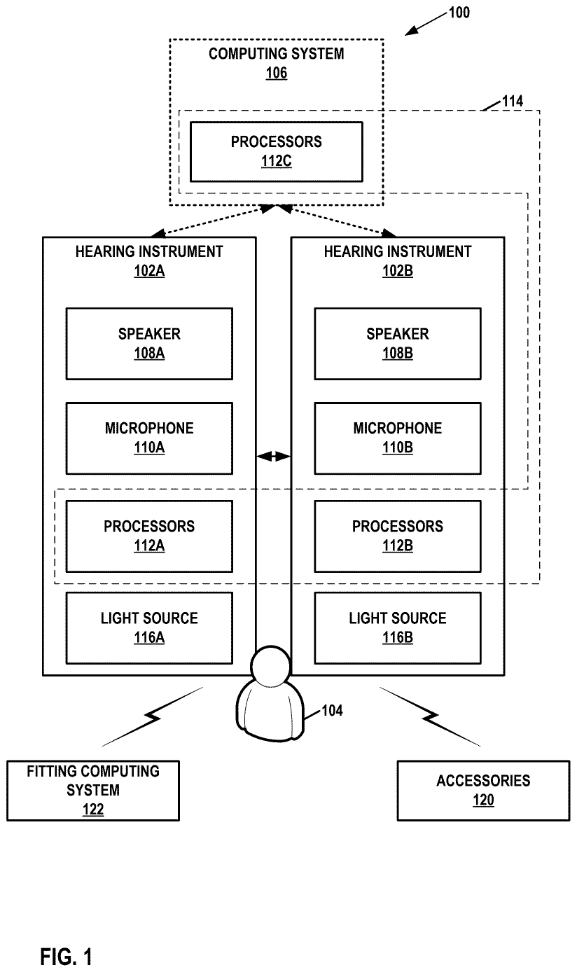

FIG. 1 is a conceptual diagram illustrating an example system 100 that includes hearing instruments 102A, 102B, in accordance with one or more techniques of this disclosure. This disclosure may refer to hearing instruments 102A and 102B collectively, as “hearing instruments 102.” A user 104 may wear hearing instruments 102. In some instances, user 104 may wear a single hearing instrument. In other instances, user 104 may wear two hearing instruments, with one hearing instrument for each ear of user 104.

Hearing instruments 102 may include one or more of various types of devices that are configured to provide auditory stimuli to user 104 and that are designed for wear and/or implantation at, on, near, or in relation to the physiological function of an ear of user 104. Hearing instruments 102 may be worn, at least partially, in the ear canal or concha. One or more of hearing instruments 102 may include behind-the-ear (BTE) components that are worn behind the ears of user 104. In some examples, hearing instruments 102 include devices that are at least partially implanted into or integrated with the skull of user 104. In some examples, one or more of hearing instruments 102 provides auditory stimuli to user 104 via a bone conduction pathway.

In any of the examples of this disclosure, each of hearing instruments 102 may include a hearing assistance device. Hearing assistance devices include devices that help user 104 hear sounds in the environment of user 104. Example types of hearing assistance devices may include hearing aid devices, PSAPs, cochlear implant systems (which may include cochlear implant magnets, cochlear implant transducers, and cochlear implant processors), bone-anchored or osseointegrated hearing aids, and so on. In some examples, hearing instruments 102 are over-the-counter, direct-to-consumer, or prescription devices. Furthermore, in some examples, hearing instruments 102 include devices that provide auditory stimuli to user 104 that correspond to artificial sounds or sounds that are not naturally in the environment of user 104, such as recorded music, computer-generated sounds, or other types of sounds. For instance, hearing instruments 102 may include so-called “hearables,” earbuds, earphones, or other types of devices that are worn on or near the ears of user 104. Some types of hearing instruments provide auditory stimuli to user 104 corresponding to sounds from the user's environment and also artificial sounds. In some examples, hearing instruments 102 may include cochlear implants or brainstem implants. In some examples, hearing instruments 102 may use a bone conduction pathway to provide auditory stimulation.

In some examples, one or more of hearing instruments 102 includes a housing or shell that is designed to be worn in the ear for both aesthetic and functional reasons and encloses the electronic components of the hearing instrument. Such hearing instruments may be referred to as in-the-ear (ITE), in-the-canal (ITC), completely-in-the-canal (CIC), or invisible-in-the-canal (IIC) devices. In some examples, one or more of hearing instruments 102 may be behind-the-ear (BTE) devices, which include a housing worn behind the ear that contains all of the electronic components of the hearing instrument, including the receiver (e.g., a speaker). The receiver conducts sound to an earbud inside the ear via an audio tube. In some examples, one or more of hearing instruments 102 are receiver-in-canal (RIC) hearing assistance devices, which include housings worn behind the ears that contain electronic components and housings worn in the ear canals that contain receivers.

Hearing instruments 102 may implement a variety of features that help user 104 hear better. For example, hearing instruments 102 may amplify the intensity of incoming sound, amplify the intensity of certain frequencies of the incoming sound, translate or compress frequencies of the incoming sound, receive wireless audio transmissions from hearing assistive listening systems and hearing aid accessories (e.g., remote microphones, media streaming devices, and the like), and/or perform other functions to improve the hearing of user 104. In some examples, hearing instruments 102 implement a directional processing mode in which hearing instruments 102 selectively amplify sound originating from a particular direction (e.g., to the front of user 104) while potentially fully or partially canceling sound originating from other directions. In other words, a directional processing mode may selectively attenuate off-axis unwanted sounds. The directional processing mode may help user 104 understand conversations occurring in crowds or other noisy environments. In some examples, hearing instruments 102 use beamforming or directional processing cues to implement or augment directional processing modes.

In some examples, hearing instruments 102 reduce noise by canceling out or attenuating certain frequencies. Furthermore, in some examples, hearing instruments 102 may help user 104 enjoy audio media, such as music or sound components of visual media, by outputting sound based on audio data wirelessly transmitted to hearing instruments 102.

Hearing instruments 102 may be configured to communicate with each other. For instance, in any of the examples of this disclosure, hearing instruments 102 may communicate with each other using one or more wireless communication technologies. Example types of wireless communication technology include Near-Field Magnetic Induction (NFMI) technology, 900 MHz technology, BLUETOOTH™ technology, WI-FI™ technology, audible sound signals, ultrasonic communication technology, infrared communication technology, inductive communication technology, or other types of communication that do not rely on wires to transmit signals between devices. In some examples, hearing instruments 102 use a 2.4 GHz frequency band for wireless communication. In examples of this disclosure, hearing instruments 102 may communicate with each other via non-wireless communication links, such as via one or more cables, direct electrical contacts, and so on.

As shown in the example of FIG. 1, system 100 may also include a computing system 106. In other examples, system 100 does not include computing system 106. Computing system 106 includes one or more computing devices, each of which may include one or more processors. For instance, computing system 106 may include one or more mobile devices (e.g., smartphones, tablet computers, etc.), server devices, personal computer devices, handheld devices, wireless access points, smart speaker devices, smart televisions, medical alarm devices, smart key fobs, smartwatches, motion or presence sensor devices, smart displays, screen-enhanced smart speakers, wireless routers, wireless communication hubs, prosthetic devices, mobility devices, special-purpose devices, accessory devices, and/or other types of devices. Accessory devices may include devices that are configured specifically for use with hearing instruments 102. Example types of accessory devices may include charging cases for hearing instruments 102, storage cases for hearing instruments 102, media streamer devices, phone streamer devices, external microphone devices, external telecoil devices, remote controls for hearing instruments 102, and other types of devices specifically designed for use with hearing instruments 102.

Actions described in this disclosure as being performed by computing system 106 may be performed by one or more of the computing devices of computing system 106. One or more of hearing instruments 102 may communicate with computing system 106 using wireless or non-wireless communication links. For instance, hearing instruments 102 may communicate with computing system 106 using any of the example types of communication technologies described elsewhere in this disclosure.

In some examples, system 100 may also include one or more accessories 120. Accessories 120 may communicate with one or more of hearing instruments 102 or computing system 106. Accessories 120 are devices configured for use with hearing instruments 102. Example types of accessories may include remote microphones, media streaming devices, charging devices, and so on.

In the example of FIG. 1, hearing instrument 102A includes a speaker 108A, a microphone 110A, a set of one or more processors 112A, light source 116A. Hearing instrument 102B includes a speaker 108B, a microphone 110B, a set of one or more processors 112B, and light source 116B. This disclosure may refer to speaker 108A and speaker 108B collectively as “speakers 108.” This disclosure may refer to microphone 110A and microphone 110B collectively as “microphones 110.” Computing system 106 includes a set of one or more processors 112C. Processors 112C may be distributed among one or more devices of computing system 106. This disclosure may refer to processors 112A, 112B, and 112C collectively as “processors 112.” Processors 112 may be implemented in circuitry and may include microprocessors, application-specific integrated circuits, digital signal processors, artificial intelligence (AI) accelerators, or other types of circuits. This disclosure may refer to light source 116A and light source 116B collectively as “light sources 116.”

As noted above, hearing instruments 102A, 102B, computing system 106 may be configured to communicate with one another. Accordingly, processors 112 may be configured to operate together as a processing system 114. Thus, discussion in this disclosure of actions performed by processing system 114 may be performed by one or more processors in one or more of hearing instrument 102A, hearing instrument 102B, or computing system 106, either separately or in coordination. Moreover, it should be appreciated that, in some examples, processing system 114 does not include each of processors 112A, 112B, or 112C. For instance, processing system 114 may be limited to processors 112A and not processors 112B or 112C.

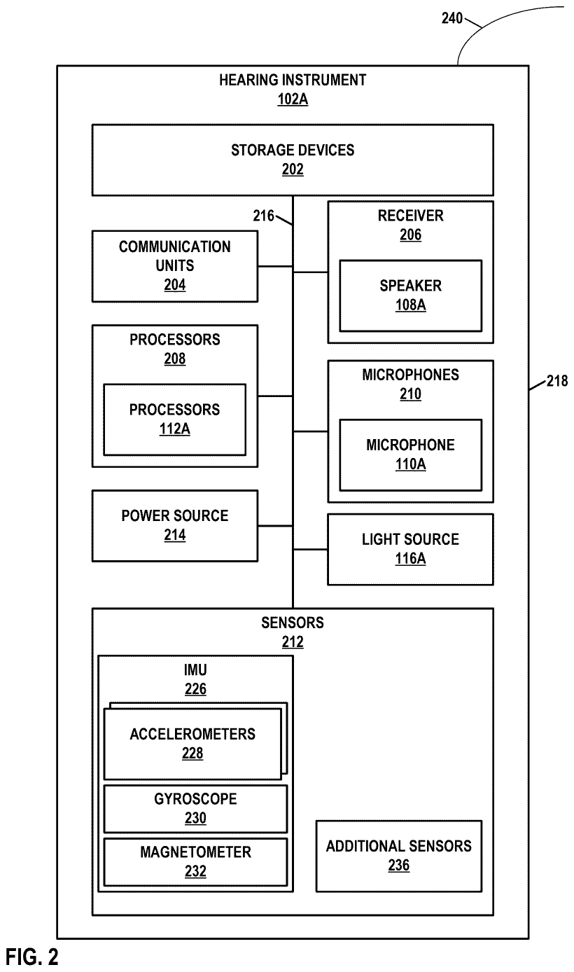

It will be appreciated that hearing instruments 102 and computing system 106 may include components in addition to those shown in the example of FIG. 1, e.g., as shown in the examples of FIG. 2. For instance, each of hearing instruments 102 may include one or more additional microphones configured to detect sound in an environment of user 104. The additional microphones may include omnidirectional microphones, directional microphones, own-voice detection sensors, or other types of microphones. In some examples, an inward-facing microphone may determine actual exposure to sound levels within the ear, as opposed to an outward-facing microphone, which measures sound in the external environment. For individuals with mild to moderate hearing loss, their residual auditory structures may be more vulnerable than those without hearing loss. Specifically, individuals with more intact hearing are more susceptible due to the presence of remaining hair cells in the cochlea, compared to someone whose cochlear hair cells are entirely absent.

During a fitting session for the hearing instrument, processing system 114 may cause a receiver of a hearing instrument (e.g., one of hearing instruments 102) to output a sound and cause a light source of the hearing instrument (e.g., one of light sources 116) to emit a first light signal indicating that the receiver output the sound. The light signal seen by an observer, such as a hearing care professional, caregiver, or user 104, may help assess whether the sound was outputted. In some examples, the light signal emitted by the light source indicates one or more characteristics of the sound output by the hearing instrument. For instance, an on/off frequency of the light signal (e.g., fast blink for a high frequency sound, slower blink for a low frequency sound), an intensity of the light signal, (e.g., brighter for louder sounds, dimmer for quieter sounds), or a color of the light signal may provide information about the characteristics of the sound output by the hearing instrument. Thus, in some examples, processing system 114 may select the light signal based on one or more characteristics of the sound, wherein the one or more characteristics of the sound include one or more of a frequency of the sound or a volume of the sound.

In some examples, processing system 114 controls light sources 116 to support remote fitting sessions observable by a person (e.g., a healthcare professional, family member, etc.) via a phone or webcam. In some examples, during a fitting session, processing system 114 causes light sources 116 to emit a light signal to indicate to user 104 which of hearing instruments 102 to use. For instance, processing system 114 may cause light source 116A of hearing instrument 102A to emit a light signal to indicate that user 104 should place hearing instrument 102A in their ear and then later cause light source 116B of hearing instrument 102B to emit a light signal to indicate that user 104 should place hearing instrument 102B in their other ear. As described in greater detail below, system 100 may include a fitting computing system 122 to facilitate the fitting session. In some examples, the fitting session may occur while user 104 is remote from a person observing the fitting session (e.g., a fitting technician, audiologist, etc.). In some examples, the fitting session may occur while user 104 is present with a person observing the fitting session (e.g., a fitting technician, audiologist, etc.).

In some examples, the light signals emitted by light sources 116 provide visual feedback that a sound or programming change, such as a gain adjustment or audiogram update, was successfully delivered to one or more of hearing instruments 102. In some examples, the light signals emitted by light sources 116 may indicate that a software or firmware update has been applied at one or more of hearing instruments 102. For example, processors 208 may cause light source 116A to flash periodically while a firmware update is in process, and then emit a solid light signal (e.g., a solid green light) to indicate the firmware update has been successfully completed. This provides visual confirmation of the update status, which may be coordinated with on-screen confirmation in a mobile application or fitting software.

Processing system 114 may select a light signal from among a plurality of light signals and cause one or more of light sources 116 to emit the selected light signal. The different light signals may have different colors, flash patterns, brightnesses, or combinations thereof. Different light signals in the plurality of light signals may correspond to different operational modes of hearing instruments 102, different health conditions of user 104, or other statuses. The use of light signals emitted by light sources 116 may enable user 104 or another person to learn a status or condition of one or more of hearing instruments 102 or a status or condition of user 104, or learn other information, particularly when hearing instruments 102 are worn in an ear of user 104.

FIG. 2 is a block diagram illustrating example components of hearing instrument 102A, in accordance with one or more aspects of this disclosure. Hearing instrument 102B may include the same or similar components of hearing instrument 102A shown in the example of FIG. 2. Thus, the discussion of FIG. 2 may apply with respect to hearing instrument 102B. In the example of FIG. 2, hearing instrument 102A includes one or more storage devices 202, one or more communication units 204, a receiver 206, one or more processors 208, one or more microphones 210, a set of sensors 212, a power source 214, one or more light sources (e.g., light source 116A), and one or more communication channels 216. Communication channels 216 provide communication between storage devices 202, communication units 204, receiver 206, processors 208, microphones 210, and sensors 212. Storage devices 202, communication units 204, receiver 206, processors 208, microphones 210, sensors 212, and communication channels 216 may draw electrical power from power source 214.

In the example of FIG. 2, each of storage devices 202, communication units 204, receiver 206, processors 208, microphones 210, sensors 212, power source 214, and communication channels 216 are contained within a single housing 218. For instance, in examples where hearing instrument 102A is a BTE device, each of storage devices 202, communication units 204, receiver 206, processors 208, microphones 210, sensors 212, power source 214, and communication channels 216 may be contained within a behind-the-ear housing. In examples where hearing instrument 102A is an ITE, ITC, CIC, or IIC device, each of storage devices 202, communication units 204, receiver 206, processors 208, microphones 210, sensors 212, power source 214, and communication channels 216 may be contained within an in-ear housing. However, in other examples of this disclosure, storage devices 202, communication units 204, receiver 206, processors 208, microphones 210, sensors 212, power source 214, and communication channels 216 are distributed among two or more housings. For instance, in an example where hearing instrument 102A is a RIC device, receiver 206, one or more of microphones 210, and one or more of sensors 212 may be included in an in-ear housing separate from a behind-the-ear housing that contains the remaining components of hearing instrument 102A. In such examples, a RIC cable may connect the two housings.

Furthermore, in the example of FIG. 2, sensors 212 include an IMU 226 that is configured to generate data regarding the motion of hearing instrument 102A. IMU 226 may include a set of sensors. For instance, in the example of FIG. 2, IMU 226 includes one or more accelerometers 228, a gyroscope 230, a magnetometer 232, combinations thereof, and/or other sensors for determining the motion of hearing instrument 102A. Furthermore, in the example of FIG. 2, hearing instrument 102A may include one or more additional sensors 236. Additional sensors 236 may include a photoplethysmography (PPG) sensor, blood oximetry sensors, blood pressure sensors, electrocardiograph (EKG) sensors, body temperature sensors, electroencephalography (EEG) sensors, environmental temperature sensors, environmental pressure sensors, environmental humidity sensors, skin galvanic response sensors, and/or other types of sensors. In other examples, hearing instrument 102A and sensors 212 may include more, fewer, or different components.

Storage devices 202 may store data. Storage devices 202 may include volatile memory and may therefore not retain stored contents if powered off. Examples of volatile memories may include random access memories (RAM), dynamic random access memories (DRAM), static random access memories (SRAM), and other forms of volatile memories known in the art. Storage devices 202 may include non-volatile memory for long-term storage of information and may retain information after power on/off cycles. Examples of non-volatile memory may include flash memories or forms of electrically programmable memories (EPROM) or electrically erasable and programmable (EEPROM) memories.

Communication units 204 may enable hearing instrument 102A to send data to and receive data from one or more other devices, such as a device of computing system 106 (FIG. 1), another hearing instrument (e.g., hearing instrument 102B), an accessory device, a mobile device, or other types of devices. Communication units 204 may enable hearing instrument 102A to use wireless or non-wireless communication technologies. For instance, communication units 204 enable hearing instrument 102A to communicate using one or more of various types of wireless technology, such as a BLUETOOTH™ technology, 3G, 4G, 4G LTE, 5G, ZigBee, WI-FI™, Near-Field Magnetic Induction (NFMI), ultrasonic communication, infrared communication, or another wireless communication technology. In some examples, communication units 204 may enable hearing instrument 102A to communicate using a cable-based technology, such as a Universal Serial Bus (USB) technology.

Receiver 206 includes one or more speakers for generating audible sound. In the example of FIG. 2, receiver 206 includes speaker 108A (FIG. 1). The speakers of receiver 206 may generate sounds that include a range of frequencies. In some examples, the speakers of receiver 206 includes “woofers” and/or “tweeters” that provide additional frequency range.

As shown in the example of FIG. 2, hearing instrument 102A includes light source 116A. Light source 116A may be disposed on housing 218 of hearing instrument 102A or otherwise disposed relative to housing 218 such that light emitted by light source 116A can emerge from housing 218. In some examples, hearing instrument 102A includes a removal handle 240 to facilitate removal of hearing instrument 102A from an ear canal of user 104. Removal handle 240 may include an elongated cord extending outward from housing 218 (e.g., outward from a faceplate of housing 218) away from the center of the head of user 104. In some such examples, light source 116A is disposed at a position along removal handle 240 or at a tip of removal handle 240. In some examples, removal handle 240 comprises a light pipe configured to guide light. In such examples, light source 116A may be disposed in a cavity defined by housing 218 and the light pipe may guide light emitted by light source 116A so that the light exits the light pipe at an outer end of removal handle 240.

In some examples, housing 218 defines an arrangement of small-diameter holes. One or more light sources, including light source 116A, may be disposed in an interior cavity defined by housing 218 such that light emitted by the light sources may travel through the holes. At the same time, the small diameters of the holes may limit or prevent entry of water, fluids, or debris from passing through the holes into the cavity defined by housing 218. Different light sources may be disposed relative to different sets of holes, forming a bank of light sources. Processors 208 may cause the bank of light sources to emit different light patterns, thereby allowing the holes to act as a small display screen.

In some examples, housing 218 defines an aperture within which light source 116A is disposed. In some examples, light source 116A is disposed on an outer surface of housing 218. In some examples, light source 116A is disposed within an interior cavity defined by housing 218 and housing 218 includes one or more translucent or transparent regions that allow light emitted by light source 116A to pass through housing 218. In some examples, one or more translucent regions of housing 218 are tinted, thereby causing light that diffuses through the one or more translucent regions to have particular colors. For example, housing 218 may include a faceplate and shell. The faceplate may be made of a translucent material. Thus, the faceplate may appear to glow as the translucent material diffuses light from light source 116A. In some examples, particularly for custom in-ear devices, the entire faceplate may be constructed of a material, such as an Edge Glow Polymer, that diffuses the light. This may allow light source 116A to be placed anywhere under the faceplate and cause the entire faceplate or the edges of the faceplate to light up uniformly, for example, in response to a user touch.

Microphones 210 detect incoming sound and generate one or more electrical signals (e.g., an analog or digital electrical signal) representing the incoming sound. In the example of FIG. 2, microphones 210 include microphone 110A (FIG. 1). In some examples, microphones 210 include directional and/or omnidirectional microphones.

In some examples, housing 218 comprises one or more components (e.g., a shell, faceplate, etc.) having shapes that are customized for user 104. In other examples, the shape of housing 218, or components thereof, is not specific to user 104.

Processors 208 include processing circuits configured to perform various processing activities. Processors 208 may process signals generated by microphones 210 to enhance, amplify, or cancel-out particular channels within the incoming sound. Processors 208 may then cause receiver 206 to generate sound based on the processed signals. In some examples, processors 208 include one or more digital signal processors (DSPs). In some examples, processors 208 may cause communication units 204 to transmit one or more of various types of data. For example, processors 208 may cause communication units 204 to transmit data to computing system 106 and/or fitting computing system 122. Furthermore, communication units 204 may receive audio data from computing system 106 and/or fitting computing system 122 and processors 208 may cause receiver 206 to output sound based on the audio data. In the example of FIG. 2, processors 208 include processors 112A (FIG. 1).

Processors 208 may cause light source 116A to emit light signals. The light signals may provide various types of information. For example, the light signals may provide visual indicators of the operational state or status of hearing instrument 102A. That is, processors 208 may also control light source 116A to act as a mode indicator, changing an appearance of light source 116A to indicate the operational mode of hearing instrument 102A. For example, a light signal emitted by light source 116A may indicate whether hearing instrument 102A is operating in a “hearing aid” mode or a “sleep support” mode, with the latter potentially providing tinnitus therapy, noise masking, or monitoring of physiological states such as respiration or heart rate. Light source 116A might also signal that hearing instrument 102A is in an active noise cancelling (ANC) mode, a transparency mode, a “comfort” mode (focused on reducing noise), an “enhance speech” mode, or a “best hearing” mode (balancing noise reduction with speech clarity).

In some examples, processors 208 may select the operational mode of hearing instrument 102A based on one or more acoustic characteristics of an acoustic environment of hearing instrument 102A. For example, processors 208 may select an ANC mode if hearing instrument 102A is in a loud environment. In another example, processors 208 selects an “enhance speech” mode if hearing instrument 102 is in an acoustic environment with high background babble noise.

In some examples, hearing instrument 102A may have a device-finding feature that helps user 104 locate hearing instrument 102A. In such examples, processors 208 may cause light source 116A to emit light at an increased brightness, flash intermittently, or change color, so that user 104 may be able to see hearing instrument 102A from further away.

In some examples, processors 208 may cause light source 116A to emit light signals that indicate alerts, such as alerts regarding a health status of user 104. In such examples, processors 208 may alter the appearance of light source 116A, such as by adjusting brightness, flashing, or changing color to convey the alert effectively. Light source 116A may also maintain lower brightness during typical operations to conserve power.

In some examples, processors 208 control light source 116A to facilitate interaction between a patient and a healthcare professional during a session conducted via phone or webcam. For example, light source 116A may provide visual feedback that a sound was delivered during a hearing test or that a programming change, such as a gain adjustment or audiogram update, was successfully applied to hearing instrument 102A. In some examples, one or more artificial intelligence systems (e.g., one or more machine learning models) may detect and analyze light signals from light source 116A, via image analysis, and provide real-time feedback to a fitting technician or other user about the status or results of the fitting session. This can assist an observer, such as a hearing care professional, caregiver, or teacher, in determining whether user 104 of hearing instrument 102A has perceived the sound, based on their gestures or self-assessment. In some examples, the light signal emitted by light source 116A may indicate characteristics of the sound, such as frequency of light pulses (e.g., fast blinking for high frequencies and slower blinking for low frequencies) or intensity of light (e.g., brighter for louder sounds and dimmer for quieter sounds).

In some examples, the appearance of light source 116A may be configured (e.g., via firmware) to support different features. For instance, standard indications may utilize low brightness levels, while features such as “find my device” or urgent health alerts may involve adjustments such as enhanced brightness, flashing, or changes in color to improve visibility and convey urgency effectively.

Processors 208 may also control light source 116A to act as an availability indicator, visually signifying a wearer's availability for conversation. For example, processors 208 may cause light source 116A to emit red light to indicate a “busy” state, corresponding to active media streaming or Bluetooth usage. The busy state may also correspond to an inductive loop broadcast. For example, if communication units 204 are receiving audio via a telecoil or induction loop system, processors 208 may cause light source 116A to emit the red light to indicate that user 104 is listening to a broadcast and may not hear a conversation partner. Processors 208 may cause light source 116A to emit green light to indicate that user 104 is available for conversation.

In some examples, light source 116A also provides real-time feedback on speech clarity, assisting speakers in adjusting their volume to enhance the understanding of user 104 in noisy environments. For example, a light signal emitted by light source 116A may provide an indication of how loudly a person speaking to user 104 should talk in order for user 104 to understand what the person is saying. For instance, if the light signal is red, the person may need to speak loudly for user 104 to understand, while if the light signal is blue, the person may speak more quietly. In some such examples, processors 208 may determine, based on a noise level in an acoustic environment of hearing instrument 102A, a volume level at which a speaker should speak to user 104. For example, processors 208 may analyze signals from microphones 210 to determine a current signal-to-noise ratio (SNR) by comparing a measured volume of the speaker's speech to a measured volume of the background noise. Processors 208 may then determine the required speech volume level based on this SNR, and in some examples, based on a hearing loss profile (e.g., an audiogram) of user 104. Thus, the light signal may indicate different volume levels depending on the noise level in the acoustic environment of hearing instrument 102A.

Processors 208 may further control light source 116A to provide health-focused indicators. For instance, light source 116A may alert users to potentially harmful listening levels or accumulated sound exposure, which could be particularly useful in pediatric, industrial, or high-noise environments. To determine the accumulated sound exposure, processors 208 may function as a dosimeter, integrating sound intensity levels measured by microphones 210 (such as an inward-facing microphone) over a specified period of time (e.g., a rolling 24-hour period). Processors 208 may then compare this integrated energy measurement to a predefined daily exposure limit or threshold. These alerts may be customized based on individual audiograms, with data collected from inward-facing microphones that measure actual auditory exposure for greater accuracy than outward-facing microphones.

In some examples, processors 208 may control light source 116A to emit a light signal that indicates whether hearing instrument 102A is in a hearing protection mode, a hear-through mode, or both. For example, hearing instrument 102A may be designed to provide hear-through functionality (e.g., pass-through or hearing aid amplification) as well as hearing protection (e.g., functioning as an earplug that blocks digital sound pass-through when a loud sound, such as a gunshot, is detected) may use light source 116A to signal the active mode. Light signals emitted by light source 116A may visually indicate when hearing protection is active or when hearing instrument 102A is in hear-through mode, providing feedback to a conversation partner that they may be heard.

In some examples, processors 208 control light source 116A to emit a light signal to indicate when a humidity event has been detected. For example, light source 116A may provide a visual alert signaling that hearing instrument 102A requires drying, needs to be assessed for potential repair, or otherwise requires attention to maintain proper functionality. In such examples, sensors 212 may include one or more sensors for detecting humidity and/or moisture.

In some examples, processors 208 control light source 116A to operate as an indicator that is not visible to the human eye, such as by emitting light in the infrared spectrum. For example, processors 208 may encode a digital signal, such as a Bluetooth Media Access Control (MAC) address, into the blink rate of the infrared light. This could enable a smartphone or other device to decode the signal by directing its camera at the hearing aid, facilitating Bluetooth pairing. In another example, a device-finding feature may utilize an infrared blink pattern or other predefined infrared light emission pattern detectable by a smartphone or other device, allowing user 104 to determine that hearing instrument 102A is in the room or within the detection range of the light signal. The infrared light may penetrate various types of materials that are opaque in the visible light spectrum, allowing a device to detect the infrared light that would be invisible to the human eye. Such materials may include fabrics, such as clothing and bedding, papers, certain types of plastic, and so on. This may be especially useful in the context of device-finding, where hearing instruments are frequently lost in a user's clothing or bedding.

In some examples, processors 208 control light source 116A to emit light signals indicating whether hearing instrument 102A is designated as a Left or Right unit. For instance, light source 116A may emit light having a specific color corresponding to the designation, such as one color for “Right” and another for “Left.” This functionality may allow hearing instrument 102A to be firmware-programmable in the field, enabling a professional to configure hearing instrument 102A as a “Right” unit, after which light source 116A visually reflects the updated designation. This Left-Right indication may also be used to facilitate a self-fitting process. For example, an application on an external device (e.g., computing system 106) may instruct the user, “now pick up the device with the blue light,” and cause light source 116A on the corresponding hearing instrument 102A to emit a blue light to ensure the user correctly identifies and handles the correct device.

In some examples, processors 208 may control light source 116A to enter a “theater mode” in response to a command received through various input methods, such as verbal commands, gestures, button inputs, or signals from a smart device like a smartphone or smartwatch. When light source 116A is in the theater mode, light source 116A does not emit any light signals or may only emit light signals for urgent conditions. In some examples, processors 208 autonomously determine that “theater mode” is appropriate based on assessments of the acoustic environment (e.g., acoustic classification), a calendar stored on a smart device or the hearing aid, ambient light sensor data, or motion sensor inputs (e.g., from an IMU or accelerometer). Processors 208 may also combine these techniques, such as using acoustic environment assessment in conjunction with data from an ambient light sensor or motion sensor, to optimize the activation of “theater mode.”

In some examples, processors 208 control light source 116A to emit light signals to indicate battery status and/or charging status. In some such examples, processors 208 may control light source 116A such that light source 116A emits light signals to indicate battery status and/or charging status in response to various input methods, such as verbal commands, gestures, button inputs, or signals from a smart device like a smartphone or smartwatch. In some examples, processors 208 may autonomously determine the battery status based on assessments of the current usage patterns (e.g., feature activity such as noise management utilization, streaming, or average power consumption), learned behavioral patterns of usage or power drain, and the estimated time remaining (e.g., until a specified time like 9 PM or for a duration such as 6 more hours).

Processors 208 may also control light source 116A to emit light signals that indicate various charging states, such as “charging,” “done charging,” or “needs charging,” with distinctions in blink rate or color to provide clear status updates. For example, a slowly blinking light signal may indicate active charging, a solid (non-blinking) light signal may indicate a full charge, and a rapidly blinking light signal may indicate low battery or the need to charge soon. In some examples, processors 208 enforce a charge limit, such as charging to 70% instead of 100%, to extend the overall lifespan of the battery.

Processors 208 may further support a hybrid power source indicator, where a light signal emitted by light source 116A provides status updates on power source transitions. For instance, the light signal may indicate when the rechargeable battery is depleted and hearing instrument 102A has switched to a zinc-air battery, or vice versa, helping to ensure a user is aware of the current power source.

Processors 208 may also combine these techniques, such as analyzing real-time power consumption in conjunction with learned schedule behaviors and charge states, to provide battery status indications, via light source 116A, including imminent power-down warnings or predictions on whether battery power for hearing instrument 102A will last the remainder of a typical day. Processors 208 may learn these schedule behaviors by logging historical usage patterns (e.g., times of day when media streaming is common or when user 104 is typically in a high-noise environment) and may determine charge states by tracking charging frequency and duration. Processors 208 may then use these learned models to predict, based on the current charge and real-time consumption, whether the battery will last. For example, processors 208 may cause light source 116A to emit a solid green light if the battery is predicted to last the typical day, a pulsing yellow light if the prediction is for only a few hours, or a rapidly blinking red light for an imminent power-down warning.

In some examples, processors 208 may control light source 116A to emit light signals to indicate a balance status of user 104 in response to assessments of a gait of user 104. For instance, the light signal may indicate whether user 104 has a steady gait or if a potentially unsteady gait has been detected, such as during a walking test (e.g., STEADI protocol). This indication could prompt a caregiver or clinician to take action to help prevent a fall or other balance-related event. Processors 208 may determine a gait as described in U.S. patent publication 2024/0285190, the entire content of which is incorporated by reference.

In some examples, processors 208 may control light source 116A to emit a light signal that indicates a fall status, such as signaling that user 104 has fallen or experienced a near-fall event. These indications may provide useful information to caregivers or other monitoring systems for timely intervention. Processors 208 may determine whether user 104 has fallen as described in U.S. Pat. No. 11,277,697, the entire content of which is incorporated by reference.

Processors 208 may also control light source 116A to emit a light signal that indicates a device self-check status. For example, light source 116A may emit a light signal that indicates that a self-check procedure has determined that hearing instrument 102A requires maintenance, such as cleaning or repair. Alternatively, light source 116A may emit a light signal that indicates that a potential issue has been detected and that a self-check should be performed, such as by placing hearing instrument 102A in a charger. The flash pattern or color of the light signal may indicate the nature of the problem detected by the self-check. For example, processors 208 may cause light source 116A to emit a red light to indicate a problem with a receiver or a yellow light to indicate a problem with a microphone. In some examples, processors 208 may cause light source 116A to emit different light signals to indicate which specific microphone port is clogged, such as a first pattern for a clogged front port and a second pattern for a clogged rear port.

In some examples, processors 208 control light source 116A to facilitate usage of accessories 120 by providing visual feedback. To achieve this, processors 208 may cause communication units 204 to establish a wireless communication link with an accessory, for example, using Bluetooth, Near-Field Magnetic Induction (NFMI), or another radio frequency protocol. Once connected, processors 208 and a processor of the accessory may exchange synchronization signals. For instance, an accessory (e.g., one of accessories 120) and light source 116A of hearing instrument 102A may blink in synchronization or share a common indicator, such as a blue light, to signify their connection and usage.

In some examples, processors 208 control light source 116A to emit a light signal that indicates a group connection as part of a social feature. For example, light sources of a group of hearing instruments may emit a common light pattern, such as alternating green and gold, to signify membership in a social group, such as fans of a sports team. The connection within the group may be established through an invitation or via an application on a phone or watch. In some examples, the connection may utilize a Bluetooth broadcast. For instance, in an environment with multiple Bluetooth streams, one group connected to a first stream may display green and gold lights, while another group connected to a second stream may display purple and yellow lights. This feature allows individuals to visually identify and locate members of a desired social group within a crowded environment. In some examples, processors 208 may control light sources 116 to provide a “light show.” For instance, when user 104 is streaming music, processors 208 may analyze the audio data of the music and cause light sources 116 to flash or change color in synchronization with the beat or rhythm of the music. Thus, in some examples, processors 208 may determine, based on a received input, a light signal, wherein the light signal indicates an association with a group and cause light source 116A to emit the light signal.

Processors 208 may also control light source 116A to emit a light signal to indicate sociability by tracking the engagement of user 104 in conversation or active listening over a specified time period. Processors 208 may track this engagement by using microphones 210 to capture acoustic environment data. Processors 208 may then apply an acoustic scene classification algorithm to the acoustic environment data to detect periods corresponding to active conversation, for example, by detecting both the voice of user 104 and external speech signals. Processors 208 may accumulate these detected periods of time to gather information about amounts of time that user 104 has been engaged in conversation and/or active listening over the specified time period. This visual indication may help combat loneliness or social isolation by signaling whether user 104 has met a threshold for meaningful social interaction. For example, processors 208 may cause light source 116A to emit a solid green light to indicate the social interaction threshold has been met, or a pulsing yellow light to indicate the accumulated engagement time is still below the threshold. Thus, if another person, such as a family member or caregiver, sees that light source 116A is emitting a light signal indicating that user 104 has not met the threshold for meaningful social interaction, the other person may make time to engage with user 104. To perform the acoustic scene classification, processors 208 may fragment the acoustic environment data into time-domain frames, such as frames having a duration of 10 to 50 milliseconds. For each frame, processors 208 may calculate a set of acoustic features. The set of acoustic features may include Mel-frequency cepstral coefficients (MFCCs), spectral centroid, spectral flux, zero-crossing rate, or modulation spectrum features. Processors 208 may input the calculated acoustic features into a classifier, such as a pre-trained neural network, a support vector machine (SVM), or a Gaussian Mixture Model (GMM), stored in storage devices 202. The classifier generates a label for each frame, categorizing the acoustic environment data into classes such as “speech,” “noise,” “music,” or “silence.”

To distinguish between the voice of user 104 (own voice) and external speech signals, processors 208 may utilize spatial processing techniques. For instance, processors 208 may compare signal inputs from multiple microphones 210 to determine a direction of arrival (DOA) for the detected speech. Processors 208 may classify speech originating from a specific angular range or near-field zone associated with the mouth of user 104 as “own voice.” Conversely, processors 208 may classify speech originating from other directions or the far-field as “external speech.” In some examples, processors 208 may utilize a bone-conduction sensor or an in-ear microphone to detect low-frequency vibrations or specific transfer functions characteristic of the user speaking, thereby validating the “own voice” detection.

Processors 208 may track the engagement by maintaining a “sociability counter” or log within storage devices 202. Processors 208 may analyze a sequence of the labeled frames over a sliding window (e.g., 5 seconds). Processors 208 may identify a “conversation state” upon detecting alternating patterns of “own voice” and “external speech” within the sliding window. Processors 208 may identify an “active listening state” upon detecting “external speech” frames with a high signal-to-noise ratio while “own voice” frames are absent or below a frequency threshold. Upon identifying the conversation state or the active listening state, processors 208 increment the sociability counter. Processors 208 then compare the value of the sociability counter to the specified amount of time (e.g., a daily goal). Determining that the sociability counter meets or exceeds the specified amount of time triggers processors 208 to cause light source 116A to emit the light signal indicating the high level of engagement. Determining that the sociability counter remains below the specified amount of time triggers processors 208 to cause light source 116A to emit the light signal indicating the low level of engagement.

In some examples, processors 208 controls light source 116A to emit a light signal to indicate a cognitive status of user 104, such as displaying visual cues for anxiety or stress levels. Processors 208 may determine anxiety or stress levels as described in U.S. patent publication 2024/0090808, the entire content of which is incorporated by reference. As described in U.S. patent publication 2024/0090808, hearing instruments may be equipped with sensors such as microphones, accelerometers, gyroscopes, and physiological monitors (e.g., heart rate, skin conductance, respiration) to continuously collect data from a user. A system uses machine learning models trained on both general population data and individual-specific patterns to classify stress and anxiety levels. The system identifies acute and chronic stress by analyzing changes in physiological signals, displacement behaviors like tapping or fidgeting, voice characteristics, and contextual factors such as sleep patterns or interactions with known stressors. To personalize the experience, the system establishes a baseline for each user and adapts its detection thresholds over time. The system also uses a lookback period to correlate stress episodes with prior events, helping to pinpoint specific triggers. In some examples, processors 208 may control light source 116A to indicate a physical fit or insertion status. For example, light source 116A may emit a specific light signal (e.g., a solid green light) in response to processors 208 determining, based on sensor feedback, that hearing instrument 102A is seated properly in the ear to provide an adequate acoustic seal. In some examples, determining the physical fit or insertion status includes performing a feedback initialization process. Processors 208 may cause receiver 206 to generate a test sound within the ear canal. Simultaneously, processors 208 may analyze signals from microphones 210, specifically an external microphone, to detect a strength of the test sound leaking from the ear canal. Processors 208 may determine the quality of the acoustic seal based on the detected strength. If the acoustic seal is sufficient, processors 208 cause light source 116A to emit the specific light signal confirming the proper fit.

In other examples, light source 116A is used as a connectivity indicator. Processors 208 may perform a connectivity test, such as by initiating a Bluetooth stream, and cause light source 116A to emit a light signal (e.g., a blue light) indicating a successful streaming state. If a user is testing a binaural system, a visual assessment can be made; for instance, if light source 116A on hearing instrument 102A shows the streaming state but light source 116B on hearing instrument 102B does not, a Bluetooth connection problem with hearing instrument 102B may be inferred.

In further examples, light source 116A may function as part of an alert system, such as a “silver alert.” A silver alert is an alert regarding a vulnerable senior. Processors 208 may receive an indication that user 104 has moved beyond a specified perimeter, such as a geofence, or has lost connection with a home network. In response, processors 208 may cause light source 116A to emit a particular alert signal. Thus, when other people see the light signal emitted by light source 116A, they may know that the wearer of hearing instrument 102A is potentially in danger or is away from an area where they should be. This signal may also be triggered by a command from a caregiver's companion application.

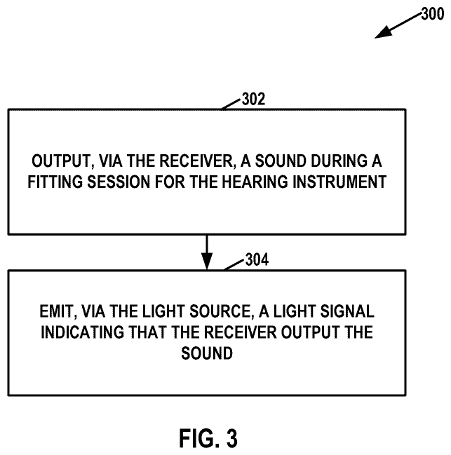

FIG. 3 is a flowchart illustrating an example operation 300 in accordance with one or more techniques of this disclosure. Other examples of this disclosure may include more, fewer, or different actions. In some examples, actions in the flowcharts of this disclosure may be performed in parallel or in different orders. FIG. 3 is described with respect to hearing instrument 102A but hearing instrument 102B may perform the same operation.

Operation 300 may be performed as part of a fitting session during which hearing instrument 102A is configured for use by user 104. For example, hearing instrument 102A may output various sounds and user 104 is prompted to respond to the sounds. The responses may then be used to determine an audiogram for user 104, to determine listening preferences of user 104, determine qualities of sound as perceived by user 104, and so on. Values of parameters may be set based on the responses. Processors 112A may cause receiver 206 to output sound detected by microphones 210 modified based on the values of the parameters. For instance, processors 112A may cause receiver 206 to output sound that is increased in volume in one or more frequency bands based on values of parameters indicating the audiogram of user 104.

In the example of FIG. 3, processing system 114 (e.g., processors 112A) causes receiver 206 to output a sound during the fitting session (302). The sound may be a pure tone, voice sounds, music, or another type of sound.

In addition, processing system 114 may cause light source 116A to emit a light signal indicating that receiver 206 output the sound (304). In this way, user 104 and/or another person (e.g., a person conducting the fitting session) may visually confirm that receiver 206 output the sound. In conventional hearing instruments, user 104 and/or the person conducting the fitting session may be unable to visually confirm that receiver 206 output the sound. Thus, there was uncertainty about whether user 104 did not hear the sound because of hearing loss or because receiver 206 did not output the sound.

In some examples, processing system 114 selects the light signal to cause light source 116A to emit based on one or more characteristics of the sound. For example, processing system 114 may cause light source 116A to emit a light signal having different colors and/or flashing patterns for sounds of different volumes or different frequencies.

Processing system 114 may use light source 116A for one or more purposes in addition to or as an alternative to using light source 116A to indicate that receiver 206 output a sound during a fitting session. For example, processing system 114 may cause light source 116A to emit a light signal that indicates an operational mode of hearing instrument 102A. The operational mode of hearing instrument 102A may be one or more of an active noise cancelling (ANC) mode, a transparency mode, a sleep support mode, a hearing aid mode, or another mode. In some examples, processing system 114 selects, based on one or more acoustic characteristics of an acoustic environment, the operational mode of hearing instrument 102A. For example, processing system 114 may select a sleep support mode if hearing instrument 102A detects that the user is sleeping. In this example, hearing instrument 102A may play soothing sounds, e.g., white noises, to mask disruptive environmental noises like snoring, traffic, or other household sounds. In some examples, light source 116A may output a light signal that indicates whether a programming change was successfully applied to the hearing instrument.

In some examples, processing system 114 determines, based on a received input, a light signal that indicates an association with a group. For example, processing system 114 may receive input from a Bluetooth broadcast indicating group identifiers, such as which stream to connect to or which color pattern to display. Processing system 114 may then cause light source 116A to emit the light signal. In some examples, processing system 114 may determine the amount of time user 104 has engaged in conversation and based on the amount of time user 104 has engaged in conversation not satisfying a threshold amount of time and may cause light source 116A to emit a light signal indicating a low level of engagement. Based on the amount of time user 104 has engaged in conversation satisfying a threshold amount of time, processing system 114 may cause light source 116A to emit a light signal indicating a high level of engagement.

In some examples, processing system 114 also receives audio data that represents sounds made by user 104 and determines based on the sound from user 104, a potential health status of user 104. For example, processing system 114 may determine, based on the audio data, that user 104 is potentially grinding their teeth or snoring. In other examples, processing system 114 may analyze the audio data to detect other health indicators, such as a cough, congestion, or sounds indicative of potential pneumonia. Processors 208 may then cause light source 116A to emit a specific light signal to alert user 104 or another person (e.g., a caregiver) to the detected potential health status. In response to seeing the light signal, user 104 or the other person may then perform one or more actions to follow up regarding the potential health status. In some examples, processing system 114 may receive signals from sensors 212 and use the signals to determine a potential health status of user 104. For instance, processing system 114 may determine, based on the signals, that user 104 is experiencing high blood pressure, low blood pressure, a heart rate issue, etc. Processing system 114 may cause light source 116A to emit a light signal indicating the potential health status.

In some examples, processing system 114 causes light source 116A to emit a light signal based on a body temperature of user 104. For example, the light signal may have different colors depending on how high the body temperature of user 104 is relative to a baseline body temperature. In this way, user 104 or another person may determine whether user 104 has a fever and how severe the fever may be. Processing system 114 may determine the body temperature based on signals from one or more of sensors 212.

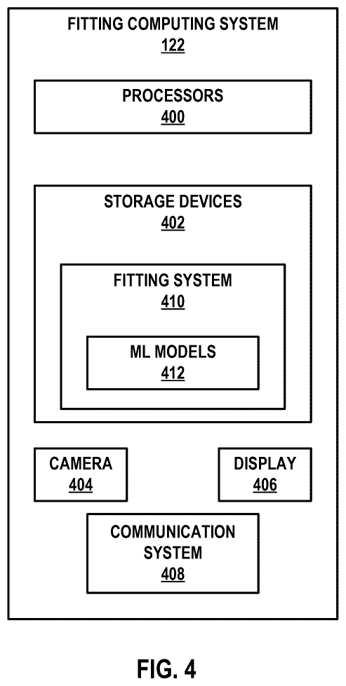

FIG. 4 is a block diagram illustrating an example fitting computing system 122 in accordance with one or more techniques of this disclosure. Fitting computing system 122 includes one or more computing devices that may be used by a fitting technician or other person during a fitting session to fit hearing instruments 102 for user 104. Fitting computing system 122 may include a personal computer, mobile device, or other types of computing devices. In the example of FIG. 4, fitting computing system 122 includes one or more processors 400, one or more storage devices 402, a camera 404, a display 406, and a communication system 408. Storage devices 402 may store processor-executable instructions associated with fitting system 410. Processors 400 may execute the processor-executable instructions associated with fitting system 410 to perform functions of a fitting system 410.

Fitting system 410 perform actions to facilitate a fitting session. For example, fitting system 410 may cause fitting computing system 122 to output instructions, via communication system 408, to one or more of hearing instruments 102 to output sounds. Additionally, fitting system 410 may cause display 406 to display a user interface through which the fitting technician may input data indicating responses from user 104 regarding whether user 104 heard the sounds or how user 104 perceived one or more qualities of the sounds (e.g., tinny, boomy, etc.). Fitting system 410 may obtain video data captured during a fitting session for a hearing instrument. In some examples, camera 404 of fitting computing system 122 may capture the video data. In some examples (e.g., examples where fitting computing system 122 is remote from hearing instruments 102), the video data may be captured by a camera at a location of hearing instruments (e.g., a camera of computing system 106) and transmitted to fitting computing system 122 via communication system 408.

Fitting system 410 may determine whether the video data represents a light source of the hearing instrument emitting a light signal that indicates that the hearing instrument delivered a sound to user 104. For example, fitting system 410 may use one or more machine learning (ML) models 412 to perform an image analysis on the video data to determine whether the video data represents the light source emitting the light signal that indicates that the hearing instrument delivered the sound to user 104. The one or more ML models 412 may include one or more convolutional neural network (CNN) models. These CNN models may be trained using a labeled dataset of video frames, where some frames include examples of the light signal (e.g., specific colors, locations, or blink patterns) and other frames do not, to learn to distinguish the signal. In such examples, a CNN may include a series of convolutional layers that apply filters to input video frames to extract spatial hierarchies of features, followed by pooling layers to reduce dimensionality, and one or more fully connected layers that comprise artificial neurons. Weights associated with inputs to the artificial neurons are trainable, for example, using a backpropagation algorithm during the training process, so that an output of a final layer (e.g., a softmax layer) of the CNN may indicate a classification or probability whether the video data represents the light source of the hearing instrument emitting the light signal. In some examples, the CNN model is a U-Net model.

Responsive to determining that the video data represents the light source emitting the light signal that indicates that the hearing instrument delivered the sound to user 104, fitting system 410 may prompt user 104 to indicate whether user 104 heard the sound and/or to express one or more qualities of the sound as perceived by user 104. For instance, to prompt user 104, fitting system 410 may output a visible or audible cue to user 104. A user of fitting computing system 122 may use a user interface of fitting system 410 to input a response of user 104.

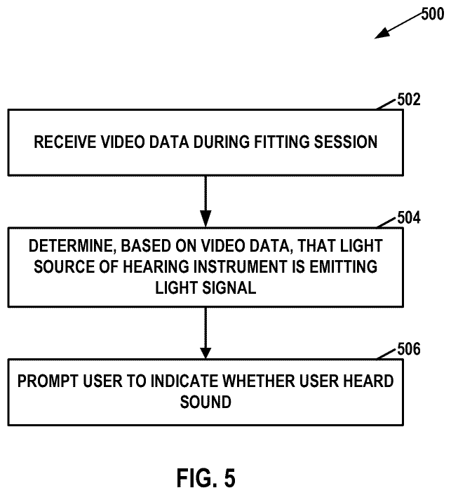

FIG. 5 is a flowchart illustrating an example operation 500 of fitting computing system 122, in accordance with one or more techniques of this disclosure. In the example of FIG. 5, fitting computing system 122 may obtain (e.g., via camera 404, via a communication network, etc.), video data captured during a fitting session for a hearing instrument (e.g., one or more of hearing instruments 102) (502).

Fitting system 410 may determine, based on the video data representing that a light source of the hearing instrument is emitting a light signal, that the hearing instrument delivered a sound to a user of the hearing instrument (504). For example, fitting system 410 may use ML models 412 to perform an image analysis on the video data to determine whether the video data represents a light signal emitted by the light source of the hearing instrument. Responsive to determining that the hearing instrument delivered the sound to the user, fitting system 410 may prompt user 104 to indicate whether user 104 heard the sound (506). For example, fitting system 410 may cause display 406 to output a visible indicator to user 104 or another person to prompt user 104 to indicate whether user 104 heard the sound.

In some examples, fitting computing system 122 or another computing system analyzes video data to obtain information from a light signal emitted by a light source of a hearing instrument. For example, fitting computing system 122 may determine, based on the received video data, that a second light signal emitted by the light source of the hearing instrument indicates a potential health status of the hearing instrument. In another example, fitting computing system 122 may determine, based on the received video data, that a second light signal emitted by the light source of the hearing instrument indicates an operational mode of the hearing instrument.

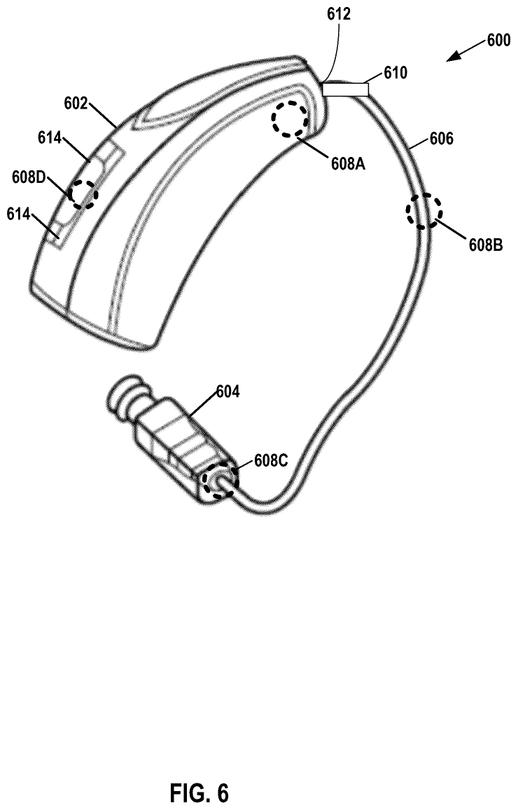

FIG. 6 is a block diagram illustrating an example hearing instrument 600 in accordance with one or more techniques of this disclosure. As shown in the example of FIG. 6, hearing instrument 600 includes a behind-the-ear (BTE) unit 602, an in-ear unit 604, connected by a cable 606 that loops over the ear when a user (e.g., user 104) wears hearing instrument 600. Additionally, hearing instrument 600 includes one or more light sources 608A, 608B, 608C, 608D (collectively, “light sources 608”).

In some examples, hearing instrument 600 is a receiver-in-canal (RIC) hearing instrument. In such examples, in-ear unit 604 includes a receiver configured to output sound into an ear canal of the user. In such examples, cable 606 comprises an electrical conductor that conducts an electrical signal from processing circuitry located in BTE unit 602 to in-ear unit 604. The receiver outputs sound based on the electrical signal. In addition to the electrical conductor, cable 606 may also include a light diffusing sheath or filament.

In some examples, hearing instrument 600 is a BTE hearing instrument. In such examples, BTE unit 602 includes a receiver and in-ear unit 604 serves to hold cable 606 into an ear canal of the user. In such examples, cable 606 may comprise a hollow sound tube to direct sound generated by the receiver of BTE unit 602 into the ear canal of the user.

BTE unit 602 may define a connector socket that receives and retains cable 606. Light source 608A may be positioned where cable 606 enters BTE unit 602 and within the connector socket of BTE unit 602. Similarly, in-ear unit 604 may define a connector socket that receives and retains cable 606. Light source 608C may be positioned where cable 606 enters in-ear unit 604 and within the connector socket of in-ear unit 604. Light source 608D may be positioned between buttons 614. In some examples, cable 606 may be comprised of a light diffusing material. Light emitted by either of light sources 608A, 608B may be conducted along and diffused from cable 606 such that an observer may see light emerging from cable 606.

Light source 608B is disposed on cable 606. Light source 608B may directly emit light or may emit light into cable 606. The light emerging from cable 606 may be used for any of the purposes described in this disclosure.

Selecting an appropriate length of cable 606 is a beneficial part of a process for fitting hearing instrument 600 to a user. If the length of cable 606 is too long or too short, hearing instrument 600 may be uncomfortable or prone to falling out. However, selecting the appropriate length of cable 606 may not be an intuitive process, especially for a user who is trying on hearing instrument 600 at home. That is, selecting the appropriate length of cable 606 may be helpful for achieving optimal directionality, long-term comfort, and a secure hold. Additionally, if the length of cable 606 is inappropriate microphones located on BTE unit 602 may be incorrectly positioned.

In accordance with one or more techniques of this disclosure, one or more of light sources 608 may be utilized as a fitting tool to ensure proper cable length selection. For example, this feature is particularly beneficial for direct-to-consumer products or as an aid for professionals during fitting sessions. A light guide portion 610 of cable 606 (e.g., a male portion of cable 606 extending to the connector socket of BTE unit 602) may be designed with a transparent or translucent material. Light guide portion 610 may function as a light pipe to guide the light emitting from light source 608A. In some examples, light guide portion 610 comprises a sleeve that surrounds or partially surrounds a segment of cable 606. A first end of light guide portion 610 is located proximate light source 608A. A second, opposite end of light guide portion 610 may be located away from light source 608A. Light guide portion 610 may reemit light originally emitted by light source 608A at the second end of light guide portion 610.

During a fitting session, processors 208 may cause light source 608A to emit light. When the user tries cables of various lengths, the cable with the appropriate length will allow the emitted light to peek over the user's ear, providing a visual indicator of the correct fit. That is, the length of light guide portion 610 of cable 606 may be such that light reemitted by light guide portion 610 is visible over the ear of the user when BTE unit 602 and in-ear unit 604 are correctly positioned. An observer (e.g., the user of hearing instrument 600, a fitting technician, or another type of person) may visually check that light is visible over the user's ear using a mirror, a mobile phone, or a desk camera. If no light is visible over the user's ear, BTE unit 602 may be sitting too low behind the user's ear because cable 606 is too long. Conversely, if light from light source 608A is visible well above the user's ear or in front of an ear-head saddle, cable 606 may be too short. In some examples, light source 608A may be directly visible over the user's ear if the length of cable 606 is appropriate without involvement of any part of cable 606.

In some examples where light source 608C is placed at the point where cable 606 connects to in-ear unit 604, processors 208 may cause light source 608C to emit light during a fitting session. The light emitted from light source 608C should still be visible along the cable or tube, allowing the user or professional to confirm the correct length.

In some examples, any of light sources 608 may be used for any of the examples set forth elsewhere in this disclosure.

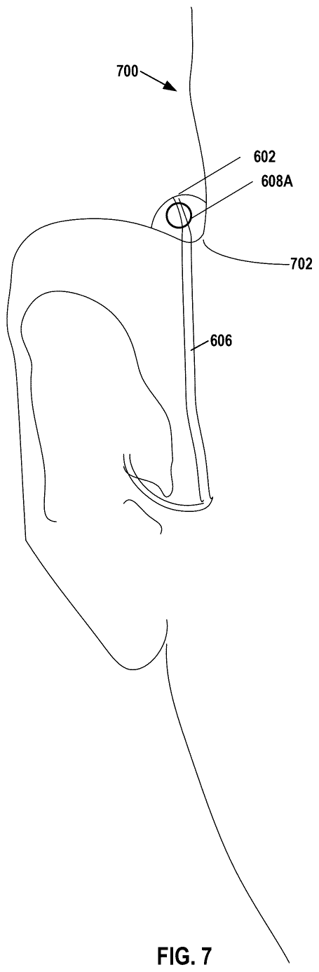

FIG. 7 is a conceptual diagram illustrating an example proper position of BTE unit 602 relative to a user's head 700, in accordance with one or more techniques of this disclosure. As shown in the example of FIG. 7, light from light source 608A may be visible over the user's ear when the appropriate length of cable 606 is selected.

Thus, hearing instrument 600 comprises a BTE unit 602 comprising a light source 608A and defining a connection socket 612. Hearing instrument 600 also comprises an in-ear unit 604 and a cable 606 connecting BTE unit 602 and in-ear unit 604. Connection socket 612 of BTE unit 602 is configured to retain a first end of cable 606. Cable 606 may comprise a light guide portion 610 configured to guide light emitted by light source 608A and reemit the light at a target fitting distance from BTE unit 602. BTE unit 602 is properly positioned on a head 700 of a user when BTE unit 602 is the target fitting distance behind an ear-head saddle 702 of the user and the light is visible at the ear-head saddle 702. For example, light is reemitted from light guide portion 610 at a terminal end of light guide portion 610. Thus, if cable 606 is too long, the terminal end of light guide portion 610 is hidden behind the user's ear. If cable 600 is too short, the terminal end of light guide portion 610 is below the ear-head saddle 702 of the user.

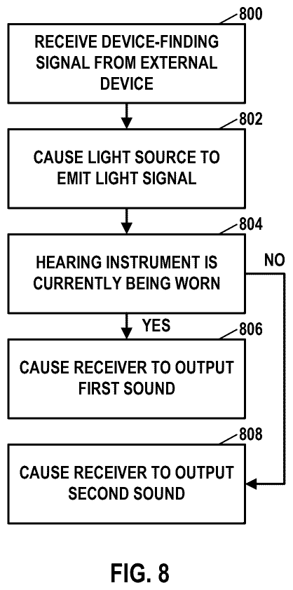

FIG. 8 is a flowchart illustrating an example operation in accordance with one or more techniques of this disclosure. The operation may be performed by one or more processors of a hearing instrument, such as processors 208 of hearing instrument 102A.

In the example of FIG. 8, hearing instrument 102A receives a device-finding signal from an external device (800). For example, one or more communication units 204 of hearing instrument 102A may receive the device-finding signal. The device-finding signal instructs hearing instrument 102A to enter a device-finding mode to assist a user in finding the hearing instrument. The external device may be, for example, a remote controller for the hearing instrument, a mobile phone wirelessly paired with the hearing instrument, a contralateral hearing instrument (e.g., hearing instrument 102B), an accessory device (e.g., a remote microphone, a table microphone, etc.) or other types of devices. In some examples where the external device is a remote controller, accessory device, or other type of device, the external device may communicate directly with the hearing instrument without the external device being paired with a mobile phone.

In some examples where the external device is the contralateral hearing instrument, the contralateral hearing instrument receives a device-finding command from user 104. In some examples, the device-finding command is a voice command. For instance, user 104 may provide a voice command, such as “Find my left hearing aid,” which is received by microphone 110B of hearing instrument 102B. In another example, the device-finding command includes one or more button pushes on one or more buttons of the contralateral hearing instrument. In some examples, a hearing instrument may receive one or more tapping gestures, which prompts the hearing instrument to start listening for voice commands. In some examples, microphones of hearing instruments 102 may remain active, and therefore able to receive voice commands, even if the hearing instruments are not on the head of user 104. The hearing instruments may use proximity sensors to determine if they are on the head of user 104.

In some examples, in response to the device-finding command, the contralateral hearing instrument transmits a device-finding signal that may be received by the hearing instrument. In some examples, in response to the device-finding command, the contralateral hearing instrument transmits a signal to another device (e.g., a mobile phone of user 104 or another type of device) that causes the other device to transmit the device-finding signal or perform another action that causes (e.g., by a third device) the device-finding signal to be sent to the hearing instrument.

In some examples, the external device is a mobile phone that is wirelessly paired with hearing instrument 102A and configured to transmit the device-finding signal in response to a signal from a third device. For example, a third person, such as a family member or caregiver, may use a companion application on their own device, e.g., their own mobile phone, tablet, or computer. The companion application may be a local application or a web application. The companion application may send a signal via a cloud service, and the mobile phone of user 104 is configured to receive the signal from the cloud service. In response, the mobile phone of user 104 transmits the device-finding signal to hearing instrument 102A. In some examples, the signal from the third device is a special text message received by the user's mobile phone. In another example, the mobile phone of user 104 is configured to transmit the device-finding signal to hearing instrument 102A in response to receiving an incoming phone call from a specific, pre-authorized phone number associated with a caregiver or other person or service. In some examples, a third person's device may send the signal directly to mobile phone of user 104. In some examples, a smart assistant on an external device, such as a mobile phone, may be launched. The smart assistant may be configured to receive a voice command, such as “find my hearing aid,” via a microphone of the external device. In response to receiving the voice command, one or more processors of the external device may be configured to transmit the device-finding signal to the hearing instrument. The smart assistant may be an AI agent or a conventional programming construct.

In some examples, the external device (e.g., computing system 106) may provide related notifications. For instance, an application on the external device may transmit a notification to a companion application (e.g., used by a caregiver) in response to user 104 launching the device-finding mode. The application may also alert the caregiver if hearing instrument 102A remains disconnected for an extended period of time. In some examples, the system supports a device-left-behind feature. The device-left-behind feature may use the disconnected state of hearing instrument 102A, combined with detected movement of the external device, to alert user 104 that the hearing instrument was likely left behind. This alert may serve as a precursor to initiating the full device-finding mode. As part of this device-left-behind feature, processors 208 may be configured to cause light source 116A to emit a light signal (e.g., flashing) when the external device returns to the location where hearing instrument 102A was disconnected.

In some examples, the companion application has a manual option to trigger one or more light sources of one or more of hearing instruments 102. For example, a user of the companion application may manually trigger the one or more light sources to confirm that the one or more hearing instruments 102 are on. In some examples, a user of the companion application may manually trigger the one or more light sources to help locate user 104 of the one or more hearing instruments 102 in a crowd.

In response to receiving the device-finding signal, processors 208 cause light source 116A to emit a light signal (802). The light signal provides a visual indicator to help the user locate hearing instrument 102A. In some examples, the light signal includes an infrared light signal. The infrared light signal may have a predefined infrared light emission pattern, such as a specific series of pulses, a specific set of one or more wavelengths, and so on. In some examples, processors 208 stop the light signal after a given amount of time has passed.

Conventional systems for helping users find a device involve causing the device to output loud noises that enable a user to determine the location of the device. However, with respect to hearing instruments, situations commonly arise when users think that they have lost a hearing instrument, but the users are in fact still wearing the hearing instrument. This can be especially common in users with memory loss issues and when the hearing instruments are in a low-power state in which the hearing instruments are no longer outputting sound based on sounds detected by microphones. In such situations, in conventional systems, the hearing instruments would be outputting loud noises directly into users'ears, which could be very painful. Hence, in accordance with a technique of this disclosure, in response to receiving the device-finding signal, processors 208 also determine whether hearing instrument 102A is currently being worn (804). To determine whether hearing instrument 102A is currently being worn, processors 208 may determine whether hearing instrument 102 is currently being worn based on one or more sensor signals generated by one or more sensors 212, such as a proximity sensor.

Based on determining that hearing instrument 102A is currently being worn (YES branch of 804), processors 208 cause receiver 206 to output a first sound (806). The first sound may be an audio notification to inform the wearer that hearing instrument 102A has received the device-finding signal, such as a low-volume tone to avoid auditory discomfort. For example, the first sound may be voice notification that indicates “someone is attempting to find your hearing instrument.” In some examples, the first sound may be different depending on whether the device-finding signal relates to a left hearing instrument or a right hearing instrument. For instance, if the device-finding signal relates to the left hearing instrument, the first sound may be voice notification that indicates “someone is attempting to find your left hearing instrument” and if the device-finding signal relates to the right hearing instrument, the first sound may be voice notification that indicates “someone is attempting to find your right hearing instrument.” Furthermore, in some examples where a third party such as a family member or caregiver initiated the device-finding signal, the first sound may indicate who initiated the device-finding signal, e.g., by indicating the third party's name.

Based on determining that the hearing instrument is not currently being worn (NO branch of 804), processors 208 cause receiver 206 to output a second sound (808). The second sound may be different from the first sound, such as a louder sound, intended to audibly assist user 104 in locating the hearing instrument. For example, the second sound may be an alarm sound, a ringing sound, or another type of sound. In some examples, the second sound may change in volume in synchrony with pulses of light emitted by the light source.

In some examples, processors 208 may first determine whether the hearing instrument is being worn and whether the hearing instrument is in a charger. In response to determining that hearing instrument 102A is not being worn and that hearing instrument 102A is not in the charger, processors 208 may enter a low-power mode. For example, processors 208 may determine hearing instrument 102A is being worn based on signals from one or more of sensors 212, such as a proximity sensor, an inward-facing microphone detecting sounds in an ear canal, or a body temperature sensor.

While in the low-power mode, processors 208 may suspend one or more services, such as active audio processing, environmental sound amplification, or continuous health monitoring, and reduce a duty cycle of one or more components to reduce power consumption and continue monitoring for device-finding signals from an external device (e.g., mobile device). As used herein, a duty cycle refers to the proportion of time a component is in an active state versus an inactive or sleep state. Reducing the duty cycle may include, for example, waking a radio component briefly at periodic intervals (e.g., every 10 seconds to one minute) to listen for a signal before returning to the sleep state. In other examples, while in the low-power mode, processors 208 may periodically send a request to the external device to determine whether the external device has any device-finding signals to transmit to hearing instrument 102A. This polling approach allows hearing instrument 102A to control the communication timing, conserving its own power by only activating its radio for the brief duration of the request and shifting the listening burden to the external device, which typically has a larger power source.

In some examples, hearing instrument 102A automatically enters a visible device-finding mode. For instance, in response to determining hearing instrument 102A is not being worn and not in the charger, processors 208 may automatically (without receiving a device-finding signal) cause light source 116A to emit a light signal. This light signal may be periodic, such as emitting a series of blinks every ten minutes, to conserve power while still providing a visual cue for a user who is actively searching.

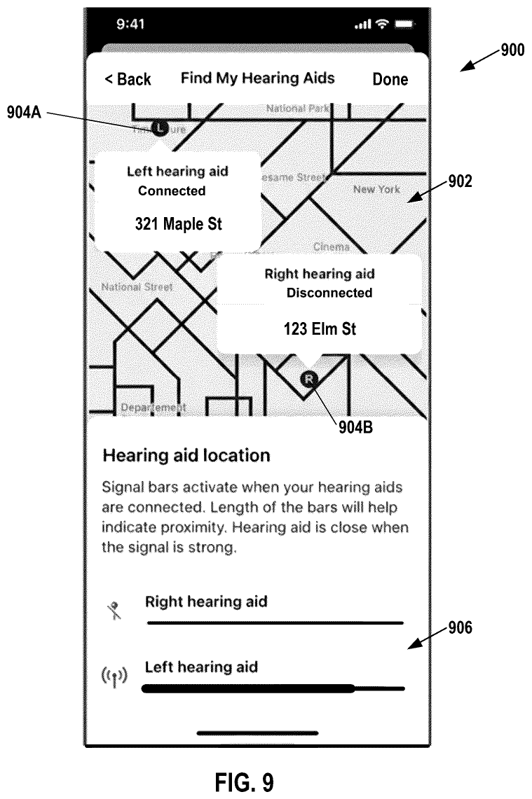

An external device, such as computing system 106, may output a device-finding interface for display. FIG. 9 illustrates an example user interface 900 for a device-finding feature, in accordance with one or more techniques of this disclosure. User interface 900 may be part of a mobile application running on an external device.

User interface 900 may include a map 902 that includes icons 904A, 904B (collectively, “icons 904”) displaying last known locations of left and right hearing instruments, such as hearing instruments 102. For example, the external device may be configured to record a satellite navigation system (e.g., Global Positioning System (GPS)) location of the external device when a wireless connection (e.g., a Bluetooth connection) with a hearing instrument is lost. This last known location is then displayed on map 902, as shown for the “Right hearing aid” in FIG. 9.

Hearing instruments 102 may communicate with each other. For instance, hearing instruments 102 may communicate with each other to perform directional sound processing, for output of streaming media, and so on. In some examples, each of the hearing instruments may determine whether communication with the other, contralateral hearing instrument, has been lost. Communication with the contralateral hearing instrument may be lost if user 104 misplaces the contralateral hearing instrument while continuing to wear a hearing instrument, or in other situations. When communication with the contralateral hearing instrument is lost, the hearing instrument may store data indicating context in which the hearing instrument was last able to communicate with the contralateral hearing instrument. The context may include data regarding sound processing settings of the hearing instruments, information about a type of activity in which user 104 was engaged (e.g., running, walking, sitting, riding in a vehicle, etc.), health status information, fall tracking information, and so on. The hearing instrument may transmit this information to an external device, such as a mobile phone of user 104. In some examples, a hearing instrument transmits a signal to an external device, that indicates that the hearing instrument has lost communication with the contralateral hearing instrument. In response to the signal, the external device may record location information to indicate a last known location of the contralateral hearing instrument.

In some examples, processors 208 of hearing instrument 102A may monitor an ear-to-ear communication link with a contralateral hearing instrument 102B. In response to determining that the ear-to-ear communication link is lost, processors 208 may activate IMU 226 to begin collecting motion tracking data. Similarly, processors 112B of hearing instrument 102B may also activate an IMU to begin collecting motion tracking data upon detecting the lost communication link. Subsequently, upon receiving a device-finding signal (or at another predetermined time), processors 208 of the available hearing instrument 102A may transfer the collected motion tracking data to an external device, such as computing system 106. The external device may use the motion tracking data from hearing instrument 102A to assist the user in locating the lost contralateral hearing instrument 102B. For example, the external device may output a user interface displaying a map that retraces the user's movements based on the motion tracking data.

In some examples, the hearing instrument that is still being worn by user 104 provides audible instructions, via receiver 206, to guide the user in retracing the user's steps to find hearing instrument 102B. For instance, after analyzing the motion tracking data (either locally or in conjunction with the external device), processors 208 may generate verbal cues such as “Turn around and walk 20 steps forward” or “The lost hearing instrument is likely near this location where you were 15 minutes ago.” This audio-based guidance allows the user to search for the lost device without needing to constantly look at a map on an external device.

In some examples, user interface 900 may also display an indication of a most recent type of activity in which the user was engaged when connection with one or more of the hearing instruments was lost. For example, the external device may receive activity indications from the hearing instrument, or infer activity based on other connections (e.g., a connection to a vehicle's Bluetooth system). This information may be stored and presented to the user to provide context for where the hearing instrument was last used.

In some examples, a hearing instrument determines (e.g., hearing instrument 102A) user activity utilizing various hardware components, such as IMU 226. In some configurations, the hearing instrument may also incorporate additional physiological sensors, such as photoplethysmography (PPG) sensors, blood oximetry sensors, or heart rate monitors, to gather further biological data regarding the user's state. To identify specific physical activities, processors 208 of hearing instrument 102A activate IMU 226 to collect motion tracking data, allowing hearing instrument 102A to distinguish between various physical contexts such as running, walking, sitting, or riding in a vehicle. Beyond direct sensor measurement, hearing instrument 102A can infer activity based on the status of external wireless connections; for instance, detecting a connection to a vehicle's Bluetooth system allows the processor to infer that the user is currently in a car. Furthermore, hearing instrument 102A may assess the user's gait to determine a balance status, specifically whether the gait is steady or unsteady, potentially utilizing established protocols like the STEADI walking test.

When a user activates the device-finding feature, such as by selecting a user-selectable feature in an interface, such as user interface 900, or simply by accessing user interface 900, the external device may constantly search or listen for the hearing instrument. If hearing instrument 102A is in a low-power mode, hearing instrument 102A may periodically emit a “ping” or broadcast signal, as previously described.

When the external device detects this signal and determines hearing instrument 102A is within range, the external device transmits the device-finding signal to hearing instrument 102A. Upon receiving the device-finding signal, hearing instrument 102A (e.g., processors 208) may exit the low-power mode and enter a “fully awake” or active device-finding mode. Hearing instrument 102A may also transmit a response signal or acknowledgment back to the external device. User interface 900 on the external device may change in response to receiving this acknowledgment. For example, as shown in FIG. 9, an icon for the hearing instrument may change appearance, such as changing a status from “Disconnected” to “Connected.”

In some examples, icons 904 may flash or pulse to indicate that the light signal on the hearing instrument is active. In some examples, icons 904 may flash or pulse to indicate that the corresponding hearing instrument is within wireless communication range of the external device. The user interface may also activate a signal strength indicator, such as signal bars 906 shown in FIG. 9. In some examples, signal bars 906 get longer as the signal strength increases. Thus, the signal strength indicator provides a proximity gauge, facilitating a “warmer, colder” search pattern where the signal strength (e.g., length of the bars) increases as the user moves closer to a hearing instrument. In some examples, the external device uses signals from multiple sources, or from the hearing instrument in combination with other wireless access points (e.g., a mesh network), to triangulate the position of hearing instrument 102A. User interface 900 may then display an icon that actively points the user in the correct direction to locate the hearing instrument.

Simultaneously, when entering the active device-finding mode, processors 208 may cause light source 116A to emit a light signal and, as described with reference to FIG. 8, cause receiver 206 to output a sound to further aid in the search.

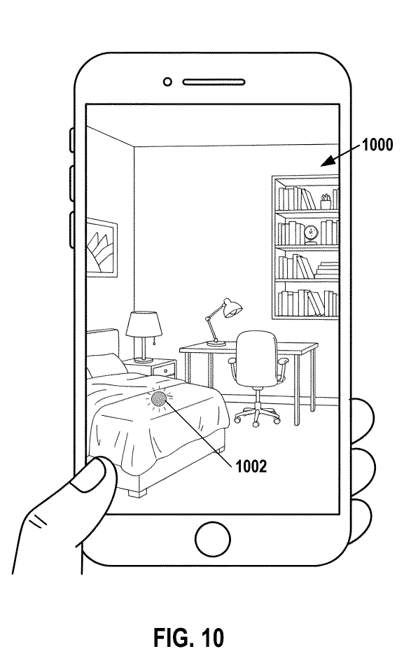

FIG. 10 illustrates another example user interface 1000 for a device-finding feature, in accordance with one or more techniques of this disclosure. User interface 1000 may be output for display by an external device, such as computing system 106, that includes one or more cameras configured to detect both visible light and infrared light. This feature may be used, for example, in scenarios where a hearing instrument (e.g., hearing instrument 102A) is configured to emit an infrared light signal in response to receiving a device-finding signal.

In operation, one or more processors of the external device (e.g., processors 112C) cause a display screen to display a live video feed based on the visible light and the infrared light detected by the one or more cameras. The hearing instrument, in response to the device-finding signal, may be configured to emit a predefined infrared light emission pattern. The one or more processors of the external device are configured to detect this specific pattern. Because the live video feed is based on the visible light, the user may be able to relate what the user sees on the display screen to their surroundings. Because the live video feed is also based on the infrared light, and because infrared light can penetrate many common types of articles, the live video feed may show the location of the hearing instrument even if the hearing instrument is covered and otherwise not directly visible to the user.

In some examples, to distinguish the infrared light signal emitted by the hearing instrument from other infrared sources in the environment, such as television remote controls or security sensors, the hearing instrument may modulate the infrared light source to emit a unique, predefined pulse sequence. In some examples, the processors of the hearing instrument may encode a digital identifier, such as the Bluetooth Media Access Control (MAC) address of the hearing instrument, into the blink rate or duty cycle of the infrared light pulses. The external device processes the video data by analyzing temporal changes in pixel intensity across a sequence of frames to decode this modulated signal. The processors of the external device may compare the decoded signal against a stored identifier for the hearing instrument. Upon validating that the detected infrared pulses match the unique identifier, the processors of the external device may determine pixel coordinates for the infrared source within the video frame and generate the visible light indication (e.g., the icon) at those coordinates on the display. If the external device detects infrared light that does not match the predefined pulse sequence or digital identifier, the processors filter out this data and do not generate a visible light indication for that source, thereby preventing false positive identifications.

As shown in FIG. 10, the live video feed displays the visible surroundings (e.g., a bedroom). The live video also includes a visible light indication, such as icon 1002, that indicates a source of the predefined infrared light emission pattern. This icon 1002 visually identifies the location of the hearing instrument, even when the hearing instrument is hidden from view (e.g., under a blanket on the bed).

To assist the user, the one or more processors of the external device may be configured to process the video feed such that the live video does not include visible light representations of one or more other infrared light sources (e.g., from a television remote control) that may be captured by the one or more cameras. This selective display ensures that icon 1002 specifically indicates the location of the lost hearing instrument. User interface 1000 may be especially useful in situations in which a user knows that the hearing instrument is in a particular room but still cannot find the hearing instrument.

The following is a list of clauses in accordance with one or more techniques of this disclosure.

Clause 1A. A hearing instrument comprising: a housing, a light source, a receiver, and one or more processors, the one or more processors configured to, during a fitting session for the hearing instrument: cause the receiver to output a sound; and cause the light source to emit a first light signal indicating that the receiver output the sound.

Clause 2A. The hearing instrument of clause 1A, wherein the one or more processors are further configured to: determine a second light signal that indicates an operational mode of the hearing instrument; and cause the light source to emit the second light signal.

Clause 3A. The hearing instrument of clause 2A, wherein the operational mode of the hearing instrument is one or more of an active noise cancelling (ANC) mode, a transparency mode, a sleep support mode, or a hearing aid mode.

Clause 4A. The hearing instrument of any of clauses 2A-3A, wherein the one or more processors are further configured to select, based on one or more acoustic characteristics of an acoustic environment, the operational mode of the hearing instrument.

Clause 5A. The hearing instrument of any of clauses 1A-4A, wherein the one or more processors are configured to select the first light signal based on one or more characteristics of the sound, wherein the one or more characteristics of the sound includes one or more of a frequency of the sound or a volume of the sound.

Clause 6A. The hearing instrument of any of clauses 1A-5A, wherein the one or more processors are further configured to cause the light source to emit a second light signal that indicates whether a programming change was successfully applied to the hearing instrument.

Clause 7A. The hearing instrument of any of clauses 1A-6A, wherein the one or more processors are further configured to: determine, based on a received input, a second light signal, wherein the second light signal indicates an association with a group; and cause the light source to emit the second light signal.

Clause 8A. The hearing instrument of any of clauses 1A-7A, wherein the one or more processors are further configured to: determine an amount of time a user of the hearing instrument has engaged in conversation; based on the amount of time the user has engaged in conversation not satisfying a threshold amount of time, cause the light source to emit a second light signal indicating a low level of engagement; and based on the amount of time the user has engaged in conversation satisfying a threshold amount of time, cause the light source to emit a third light signal indicating a high level of engagement.

Clause 9A. The hearing instrument of any of clauses 1A-8A, wherein the one or more processors are further configured to: receive a sound from a user of the hearing instrument; determine based on the sound from the user, a potential health status of the user; and cause the light source to emit a second light signal indicating the potential health status of the user.

Clause 10A. The hearing instrument of any of clauses 1A-9A, wherein the one or more processors are further configured to cause the light source to emit a second light signal indicating how loudly a person should talk to a user of the hearing instrument.

Clause 11A. A method comprising: causing, by one or more processors of a hearing instrument, a receiver of the hearing instrument to output a sound; and causing, by the one or more processors, a light source of the hearing instrument to emit a first light signal indicating that the receiver output the sound.

Clause 12A. The method of clause 11A, further comprising: determining, by the one or more processors, a second light signal that indicates an operational mode of the hearing instrument; and causing, by the one or more processors, the light source to emit the second light signal.

Clause 13A. The method of clause 12A, wherein the operational mode of the hearing instrument is one or more of an active noise cancelling (ANC) mode, a transparency mode, a sleep support mode, or a hearing aid mode.

Clause 14A. The method of any of clauses 12A-13A, further comprising selecting, by the one or more processors, based on one or more characteristics of an acoustic environment, the operational mode of the hearing instrument.

Clause 15A. The method of any of clauses 11A-14A, further comprising selecting, by the one or more processors, the first light signal based on one or more characteristics of the sound, wherein the one or more characteristics of the sound includes one or more of a frequency of the sound or a volume of the sound.

Clause 16A. The method of any of clauses 11A-15A, further comprising causing, by the one or more processors, the light source to emit a second light signal that indicates whether a programming change was successfully applied to the hearing instrument.

Clause 17A. The method of any of clauses 11A-16A, further comprising: determining, by the one or more processors, based on a received input, a second light signal, wherein the second light signal indicates an association with a group; and causing, by the one or more processors, the light source to emit the second light signal.

Clause 18A. The method of any of clauses 11A-17A, further comprising: determining, by the one or more processors, an amount of time a user of the hearing instrument has engaged in conversation; based on the amount of time the user has engaged in conversation not satisfying a threshold amount of time, causing, by the one or more processors, the light source to emit a second light signal indicating a low level of engagement; and based on the amount of time the user has engaged in conversation satisfying a threshold amount of time, causing, by the one or more processors, the light source to emit a third light signal indicating a high level of engagement.

Clause 19A. The method of any of clauses 11A-18A, further comprising: receiving, by the one or more processors, a sound from a user of the hearing instrument; determining, by the one or more processors, based on the sound from the user, a potential health status of the user; and causing, by the one or more processors, the light source to emit a second light signal indicating the potential health status of the user.

Clause 20A. The method of any of clauses 11A-19A, further comprising causing, by the one or more processors, the light source to emit a second light signal indicating how loudly a person should talk to a user of the hearing instrument.

Clause 21A. A method comprising: receiving, by one or more processors, video data captured during a fitting session for a hearing instrument; determining, by the one or more processors, based on the video data representing that a light source of the hearing instrument is emitting a light signal, that the hearing instrument delivered a sound to a user of the hearing instrument; and responsive to determining that the hearing instrument delivered the sound to the user, prompting the user to indicate whether the user heard the sound.

Clause 22A. The method of clause 21A, further comprising: determining, by the one or more processors, based on the video data, that a second light signal emitted by the light source of the hearing instrument indicates an operational mode of the hearing instrument.

Clause 23A. The method of any of clauses 21A-22A, further comprising: obtaining the light signal from the light source; performing an image analysis on the light signal; and based on the image analysis, outputting the light signal indicating a status of the fitting session for the hearing instrument.

Clause 24A. The method of any of clauses 21A-23A, further comprising: determining, by the one or more processors, based on the video data, that a second light signal emitted by the light source of the hearing instrument indicates a potential health status of the hearing instrument.

Clause 25A. A hearing instrument comprising: a behind-the-ear (BTE) unit comprising a light source and defining a connection socket; an in-ear unit; and a cable connecting the BTE unit and the in-ear unit, wherein the connection socket of the BTE unit is configured to retain a first end of the cable, the cable comprising a light guide portion configured to guide light emitted by the light source and reemit the light at a target fitting distance from the BTE unit, wherein the BTE unit is properly positioned on a head of a user when the BTE unit is the target fitting distance behind an ear-head saddle of the user and the light is visible at the ear-head saddle.

Clause 26A. A non-transitory computer-readable storage media comprising instructions executable by one or more processors, the instructions, when executed, causing the one or more processors to perform operations, the instructions comprising instructions to perform the methods of any of clauses 11A-24A.

Clause 1B. A hearing instrument comprising: a housing, a light source, a receiver, one or more processors configured to: receive a device-finding signal from an external device, wherein the device-finding signal instructs the hearing instrument to enter a device-finding mode to assist a user in finding the hearing instrument; in response to receiving the device-finding signal, cause the light source to emit a light signal; determine whether the hearing instrument is currently being worn; cause the receiver to output a first sound based on the hearing instrument currently being worn; and cause the receiver to output a second sound based on the hearing instrument not currently being worn.

Clause 2B. The hearing instrument of Clause 1B, wherein the external device is a remote controller for the hearing instrument.

Clause 3B. The hearing instrument of Clause 1B, wherein the external device is a mobile phone wirelessly paired with the hearing instrument.

Clause 4B. The hearing instrument of Clause 1B, wherein the external device is a mobile phone that is wirelessly paired with the hearing instrument and configured to transmit the device-finding signal in response to a signal from a third device.

Clause 5B. The hearing instrument of Clause 1B, wherein the external device is a contralateral hearing instrument.

Clause 6B. The hearing instrument of any of Clauses 1B-5B, wherein the first sound notifies a user of the hearing instrument that the hearing instrument has received the device-finding signal.

Clause 7B. The hearing instrument of any of Clauses 1B-6B, wherein: the hearing instrument further comprises one or more sensors, and to determine whether the hearing instrument is currently being worn, the one or more processors determine, based on one or more sensor signals generated by the one or more sensors, whether the hearing instrument is currently being worn.

Clause 8B. The hearing instrument of any of Clauses 1B-7B, wherein the one or more processors are further configured to: determine whether the hearing instrument is being worn and whether the hearing instrument is in a charger; in response to determining that the hearing instrument is not being worn and that the hearing instrument is not in the charger, enter a low-power mode; while the hearing instrument is in the low-power mode: reduce a duty cycle of one or more components to reduce power consumption; and continue monitoring for device-finding signals from the external device.

Clause 9B. The hearing instrument of any of Clauses 1B-7B, wherein the one or more processors are further configured to: determine whether the hearing instrument is being worn and whether the hearing instrument is in a charger; in response to determining that the hearing instrument is not being worn and that the hearing instrument is not in the charger, enter a low-power mode; while the hearing instrument is in the low-power mode: reduce a duty cycle of one or more components to reduce power consumption; and periodically send a request to the external device to determine whether the external device has any device-finding signals to transmit to the hearing instrument.

Clause 10B. The hearing instrument of any of Clauses 1B-9B, wherein the light signal comprises an infrared light signal.

Clause 11B. The hearing instrument of Clause 10B, wherein the infrared light signal has a predefined infrared light emission pattern.

Clause 12B. A device comprising: a communication system; a display screen; one or more cameras configured to detect visible light and infrared light; and one or more processors configured to: transmit, via the communication system, a device-finding signal to a hearing instrument that is configured to emit an infrared light signal in response to the device-finding signal; and cause the display screen to display live video based on the visible light and the infrared light detected by the one or more cameras.

Clause 13B. The device of Clause 12B, wherein: the infrared light signal is a predefined infrared light emission pattern that the hearing instrument is configured to emit in response to the device-finding signal; and the live video includes a visible light indication of a source of the predefined infrared light emission pattern.

Clause 14B. The device of Clause 13B, wherein the live video does not include visible light representations of one or more other infrared light sources captured by the one or more cameras.

Clause 15B. The device of any of Clauses 12B-14B, wherein the one or more processors are further configured to: receive one or more activity indications from the hearing instrument, each of the one or more activity indications indicating a type of activity in which a user of the hearing instrument was engaged; determine, based on the one or more activity indications, a most recent type of activity in which the user was engaged; and output, for display on the display screen, a user interface that contains a map and an icon indicating a last known location of the hearing instrument in the map and an indication of the most recent type of activity in which the user was engaged.

In this disclosure, ordinal terms such as “first,” “second,” “third,” and so on, are not necessarily indicators of positions within an order, but rather may be used to distinguish different instances of the same thing. Examples provided in this disclosure may be used together, separately, or in various combinations. Furthermore, with respect to examples that involve personal data regarding a user, it may be stipulated that such personal data is to be used with the permission of the user.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media may include RAM, Read-Only Memory (ROM), EEPROM, Compact Disc-Read-Only Memory (CD-ROM) or other optical disk storage, magnetic disk storage, or other magnetic storage devices, flash memory, cache memory, or any other medium that can be used to store desired program code in the form of instructions or store data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Where a phrase similar to “one or more processors configured to X, Y, and Z” is used in the claims, it is intended that the phrase be interpreted to mean at least: that a processor A alone may perform functions X, Y, and Z; that two or more processors (e.g., processors A and B) may collectively perform functions X, Y, and Z; that a first processor A may perform functions X and Y and a second processor may perform function Z; or that a first processor A may perform function X, a second processor may perform function Y, and a third processor may perform function Z.

Various examples have been described. These and other examples are within the scope of the following claims.

What is claimed is:

1. A hearing instrument comprising:
a housing;
a light source;
a receiver; and
one or more processors configured to, during a fitting session for the hearing instrument:
cause the receiver to output a sound; and
cause the light source to emit a first light signal indicating that the receiver output the sound.

2. The hearing instrument of claim 1, wherein the one or more processors are further configured to:
determine a second light signal that indicates an operational mode of the hearing instrument; and
cause the light source to emit the second light signal.

3. The hearing instrument of claim 2, wherein the operational mode of the hearing instrument is one or more of an active noise cancelling (ANC) mode, a transparency mode, a sleep support mode, or a hearing aid mode.

4. The hearing instrument of claim 2, wherein the one or more processors are further configured to select, based on one or more acoustic characteristics of an acoustic environment, the operational mode of the hearing instrument.

5. The hearing instrument of claim 1, wherein the one or more processors are configured to select the first light signal based on one or more characteristics of the sound, wherein the one or more characteristics of the sound includes one or more of a frequency of the sound or a volume of the sound.

6. The hearing instrument of claim 1, wherein the one or more processors are further configured to cause the light source to emit a second light signal that indicates whether a programming change was successfully applied to the hearing instrument.

7. The hearing instrument of claim 1, wherein the one or more processors are further configured to:
determine, based on a received input, a second light signal, wherein the second light signal indicates an association with a group; and
cause the light source to emit the second light signal.

8. The hearing instrument of claim 1, wherein the one or more processors are further configured to:
determine an amount of time a user of the hearing instrument has engaged in conversation;
based on the amount of time the user has engaged in conversation not satisfying a threshold amount of time, cause the light source to emit a second light signal indicating a low level of engagement; and
based on the amount of time the user has engaged in conversation satisfying a threshold amount of time, cause the light source to emit a third light signal indicating a high level of engagement.

9. The hearing instrument of claim 1, wherein the one or more processors are further configured to:
receive a sound from a user of the hearing instrument;
determine based on the sound from the user, a potential health status of the user; and
cause the light source to emit a second light signal indicating the potential health status of the user.

10. The hearing instrument of claim 1, wherein the one or more processors are further configured to cause the light source to emit a second light signal indicating how loudly a person should talk to a user of the hearing instrument.

11. A method comprising:
causing, by one or more processors of a hearing instrument, a receiver of the hearing instrument to output a sound; and
causing, by the one or more processors, a light source of the hearing instrument to emit a first light signal indicating that the receiver output the sound.

12. The method of claim 11, further comprising:
determining, by the one or more processors, a second light signal that indicates an operational mode of the hearing instrument; and
causing, by the one or more processors, the light source to emit the second light signal.

13. The method of claim 12, wherein the operational mode of the hearing instrument is one or more of an active noise cancelling (ANC) mode, a transparency mode, a sleep support mode, or a hearing aid mode.

14. The method of claim 12, further comprising selecting, by the one or more processors, based on one or more characteristics of an acoustic environment, the operational mode of the hearing instrument.

15. The method of claim 11, further comprising selecting, by the one or more processors, the first light signal based on one or more characteristics of the sound, wherein the one or more characteristics of the sound includes one or more of a frequency of the sound or a volume of the sound.

16. The method of claim 11, further comprising causing, by the one or more processors, the light source to emit a second light signal that indicates whether a programming change was successfully applied to the hearing instrument.

17. The method of claim 11, further comprising:
determining, by the one or more processors, based on a received input, a second light signal, wherein the second light signal indicates an association with a group; and
causing, by the one or more processors, the light source to emit the second light signal.

18. The method of claim 11, further comprising:
determining, by the one or more processors, an amount of time a user of the hearing instrument has engaged in conversation;
based on the amount of time the user has engaged in conversation not satisfying a threshold amount of time, causing, by the one or more processors, the light source to emit a second light signal indicating a low level of engagement; and
based on the amount of time the user has engaged in conversation satisfying a threshold amount of time, causing, by the one or more processors, the light source to emit a third light signal indicating a high level of engagement.

19. The method of claim 11, further comprising:
receiving, by the one or more processors, a sound from a user of the hearing instrument;
determining, by the one or more processors, based on the sound from the user, a potential health status of the user; and
causing, by the one or more processors, the light source to emit a second light signal indicating the potential health status of the user.

20. The method of claim 11, further comprising causing, by the one or more processors, the light source to emit a second light signal indicating how loudly a person should talk to a user of the hearing instrument.
